(19) United States
(12) Patent Application Publication
(10) Pub. No.: US 2016/0070557 A1
(43) Pub. Date: Mar. 10, 2016

(54) INFORMATION PROCESSING APPARATUS, INFORMATION PROCESSING METHOD, AND INFORMATION PROCESSING SYSTEM

(71) Applicant: Tsuyoshi Yamada, Kanagawa (JP)

(72) Inventor: Tsuyoshi Yamada, Kanagawa (JP)

(21) Appl. No.: 14/837,633

(22) Filed: Aug. 27, 2015

(30) Foreign Application Priority Data
Sep. 9, 2014 (JP) 2014-183679
Jun. 16, 2015 (JP) 2015-121447

(51) Int. Cl. G06F 9/445

(52) U.S. Cl. CPC G06F 8/65

(57) ABSTRACT

An information processing apparatus includes: a first acquisition unit which acquires identification information identifying a driver from the driver; a generation unit which generates specification information specifying a storage location where update information for updating the driver is stored, based on the identification information; and a second acquisition unit which acquires the update information from the storage location specified by the specification information generated by the generation unit.

### CROSS-REFERENCE TO RELATED APPLICATIONS

The present application claims priority to and incorporates by reference the entire contents of Japanese Patent Application No. 2014-183679 filed in Japan on Sep. 9, 2014 and Japanese Patent Application No. 2015-121447 filed in Japan on Jun. 16, 2015.

### BACKGROUND OF THE INVENTION

1. Field of the Invention

The present invention relates an information processing apparatus, an information processing method, and an information processing system.

2. Description of the Related Art

A driver program and an installer checking whether or not there is an update of the driver program and performing installation are distributed in a bundled form has been conventionally performed. These driver program and installer are installed on the same PC (personal computer), and the installer queries to a server via a network such as the Internet whether or not there is an update of the corresponding driver program. As a result of the query, in the case where there is an update, the installer acquires a driver program for updating from the server and updates the driver program mounted on the PC by using the driver program for updating acquired from the server.

Japanese Patent No. 3870765 discloses a technique of acquiring an appropriate package of a driver for a peripheral apparatus mounted on a client apparatus and prompting a user to install the acquired driver. That is, in Japanese Patent No. 3870765, based on information of the client apparatus or the peripheral apparatus, by referring to stored database for the driver, an optimal package of driver program is acquired. Next, an installer program is automatically started to prompt the user to install the driver program included in the acquired package. According to Japanese Patent No. 3870765, the user can easily execute manipulation of acquiring the newest version of the driver program from the network or the like and installing the newest version of the driver program.

However, since the driver program which the conventional installer can cope with is limited to the driver program distributed together with the installer, there is a problem in that the installer cannot cope with, for example, a driver program which will be newly provided in the future. Therefore, every time when a new driver program is provided, the corresponding installer conventionally needs to be distributed.

In addition, although the method of Japanese Patent No. 3870765 can cope with the driver programs of a plurality of peripheral apparatuses, the method cannot cope with driver programs which will be newly provided in the future.

In light of the above, there is a need to enable one installer to be commonly applicable to a current provided program and a program which will be provided in the future.

### SUMMARY OF THE INVENTION

It is an object of the present invention to at least partially solve the problems in the conventional technology.

An information processing apparatus includes: a first acquisition unit which acquires identification information identifying a driver from the driver; a generation unit which generates specification information specifying a storage location where update information for updating the driver is stored, based on the identification information; and a second acquisition unit which acquires the update information from the storage location specified by the specification information generated by the generation unit.

An information processing method includes: first acquiring identification information identifying a driver from the driver; generating specification information specifying a storage location where update information for updating the driver is stored, based on the identification information; and second acquiring the update information from the storage location specified by the specification information generated at the generating.

An information processing system includes: a first storage unit which stores an object for updating a driver in a first storage location; a second storage unit which stores update information including information indicating the first storage location, in a second storage location specified by specification information based on identification information identifying the driver; a first storing unit which stores a driver including the identification information identifying the driver itself; a first acquisition unit which acquires the identification information from the driver stored in the first storing unit; a generation unit which generates the specification information based on the identification information acquired by the first acquisition unit; a second acquisition unit which acquires the update information from the second storage location specified by the specification information generated by the generation unit; and an updating unit which acquires the object from the first storage unit based on the update information acquired by the second acquisition unit and updates the driver stored in the first storing unit by using the acquired object.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a configuration of an example of an information processing system according to a first embodiment;

FIG. 2 is a block diagram illustrating a configuration of an example of a client PC applicable to the first embodiment;

FIG. 3 is an exemplary functional block diagram for explaining functions of the client PC according to the first embodiment;

FIG. 4 is a block diagram illustrating a configuration of an example of an installer according to the first embodiment;

FIG. 5 is a block diagram illustrating a configuration of an example of a driver according to the first embodiment;

FIG. 6 is a schematic diagram illustrating a driver update procedure according to the first embodiment;

FIG. 7 is a flowchart for explaining the driver update procedure according to the first embodiment more in detail;

FIG. 8 is a diagram illustrating an example of an ID according to the first embodiment;

FIG. 9 is a diagram illustrating an example of specification information according to the first embodiment;

FIG. 10 is a diagram illustrating an example of update information according to the first embodiment;

FIGS. 11A and 11B are diagrams illustrating an example of a display screen according to the first embodiment;

FIG. 12 is a diagram illustrating an example of an installation completion screen according to the first embodiment;

FIG. 13 is a diagram for explaining an example of IDs according to the embodiments;

FIGS. 14A to 14C are diagrams illustrating an example of a management method for update information applicable to each embodiment;

FIG. 15 is a diagram illustrating an example of specification information in the case of searching for an ID based on an argument by referring to a table;

FIG. 16 is a flowchart illustrating an example of a driver installation procedure according to a modified example of the first embodiment;

FIG. 17 is a diagram illustrating an example of driver information written in an OS management area according to a modified example of the first embodiment;

FIG. 18 is a flowchart illustrating an example of a driver update procedure according to a modified example of the first embodiment;

FIG. 19 is a block diagram illustrating a configuration of an example of an information processing system applicable to a second embodiment;

FIG. 20 is an exemplary functional block diagram for explaining functions of a client PC according to the second embodiment;

FIG. 21 is a block diagram illustrating a configuration of an example of an installer according to the second embodiment;

FIG. 22 is a flowchart illustrating an example of a driver installation procedure according to the second embodiment;

FIG. 23 is a diagram illustrating an example of driver information written in an OS management area according to the second embodiment;

FIG. 24 is a flowchart illustrating an example of a driver update procedure according to the second embodiment;

FIGS. 25A and 25B are diagrams illustrating an example of a display screen according to the second embodiment; and

FIG. 26 is a diagram illustrating an example of an installation completion screen according to the second embodiment.

### DETAILED DESCRIPTION OF THE PREFERRED EMBODIMENTS

Embodiments of an information processing apparatus, an information processing method, and an information processing system will be described below in detail with reference to the attached drawings.

### First Embodiment

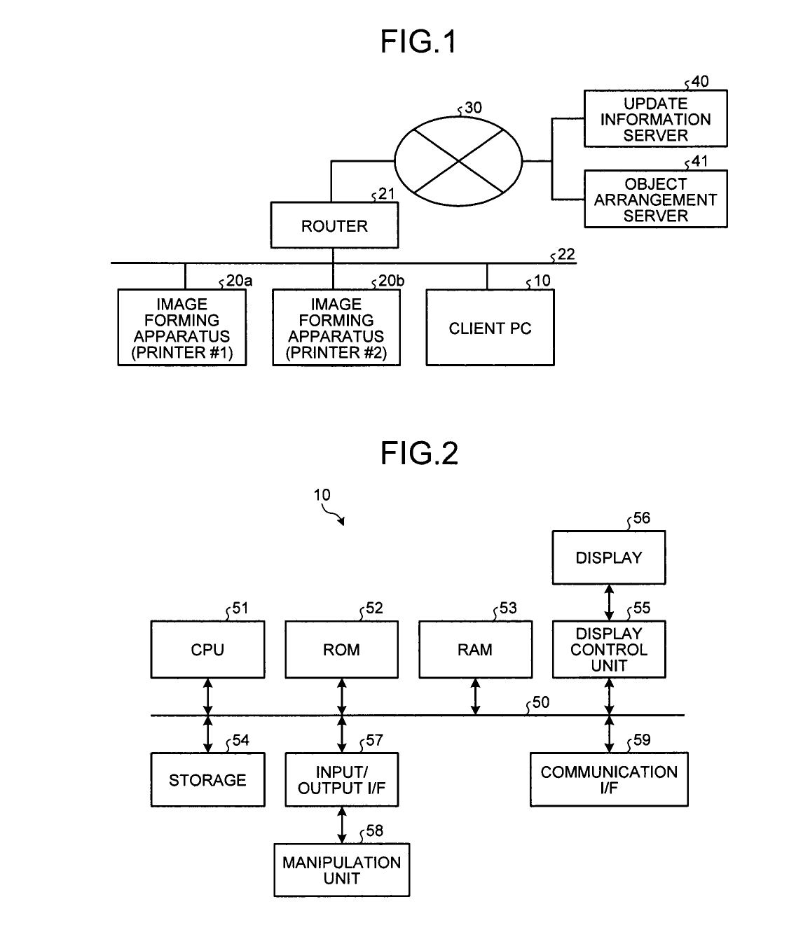

FIG. 1 illustrates a configuration of an example of an information processing system according to a first embodiment. In FIG. 1, an information processing apparatus 10 (hereinafter, referred to as a client PC 10) such as a personal computer in a client side and image forming apparatuses 20a and 20b are communicatably connected to each other via a network 22 such as a local area network (LAN). In the example of FIG. 1, the image forming apparatuses 20a and 20b are printer apparatuses (printers #1 and #2). A driver program (hereinafter, abbreviated to a driver) for driving the image forming apparatuses 20a and 20b is installed in the client PC 10. The client PC 10 can control the image forming apparatuses 20a and 20b via the network 22 by using the installed driver.

The client PC 10 is connected to an external network 30, for example, the Internet through a router 21. An update information server 40 and an object arrangement server 41 are connected to the network 30. The client PC 10 can communicate with the update information server 40 and the object arrangement server 41 via the network 30.

In the object arrangement server 41, an object for updating the driver installed in the client PC 10 is arranged and stored at a predefined storage location. The object stored in the object arrangement server 41 may be a driver itself which replaces the driver installed in the client PC 10 and whose version is a newer than the version of the driver or may be a module for constituting the driver. It is not limited thereto, and the object may be a module including only an updating portion of the driver.

Update information for updating the driver by using the object stored in the object arrangement server 41 is stored in the update information server 40. The update information includes at least information indicating a storage location where the object is stored in the object arrangement server 41.

In addition, in the example of FIG. 1, it is illustrated that the two image forming apparatuses 20a and 20b are connected to the network 22 so that the client PC 10 controls the image forming apparatuses 20a and 20b, and the embodiment is not limited to this example. That is, the client PC 10 may control only one of the two image forming apparatuses 20a and 20b connected to the network 22, and one image forming apparatus, for example, the image forming apparatus 20a may be connected to the network 22. In addition, three or more image forming apparatuses may be connected to the network 22, and the client PC 10 may control all of the three or more image forming apparatuses.

In addition, in FIG. 1, the update information server 40 and the object arrangement server 41 are illustrated as separate server apparatuses, but the embodiment is not limited to this example. For example, the update information server 40 and the object arrangement server 41 may be configured as separate functions on the same server apparatus, or the update information server 40 and the object arrangement server 41 may be configured to be distributed over a larger number of server apparatuses.

FIG. 2 illustrates a configuration of an example of the client PC 10 applicable to the first embodiment. The client PC 10 is configured such that a central processing unit (CPU) 51, read only memory (ROM) 52, random access memory (RAM) 53, a storage 54, a display control unit 55, an input/output I/F 57, and a communication I/F 59 are communicatable with each other via a bus 50.

The CPU 51 controls overall operations of the client PC 10 by using the RAM 53 as a work memory according to a program stored in advance in the ROM 52 or the storage 54. The storage 54 consists of a hard disk drive or nonvolatile semiconductor memory (flash memory) and stores programs or various data for operations of the CPU 51.

The display control unit 55 converts a display control signal generated by the CPU 51 according to the program into a display signal which can be displayed by a display 56 and supplies the display signal to the display 56. The display 56 utilizes, for example, a liquid crystal display (LCD) as a display device and displays a screen according to the display signal supplied from the display control unit 55 on the display device.

The input/output I/F 57 is an interface performing communication to an external device. In the example of FIG. 2, as an external device, a manipulation unit 58 including a keyboard or a pointing device (mouse or the like) is connected to the input/output I/F 57. It is not limited thereto, and the input/output I/F 57 may be connected to a drive device performing reading of data from a disk storage memory such as a compact disk (CD) or a digital versatile disk (DVD) or a storage such as nonvolatile semiconductor memory, or the like. As the input/output I/F 57, for example, an universal serial bus (USB) may be used.

The communication I/F 59 controls communication through the network 30 by using a predetermined protocol such as transmission control protocol/internet protocol (TCP/IP).

Incidentally, the update information server 40 and the object arrangement server 41 can be implemented with the same configuration as the client PC 10, and its description is omitted herein.

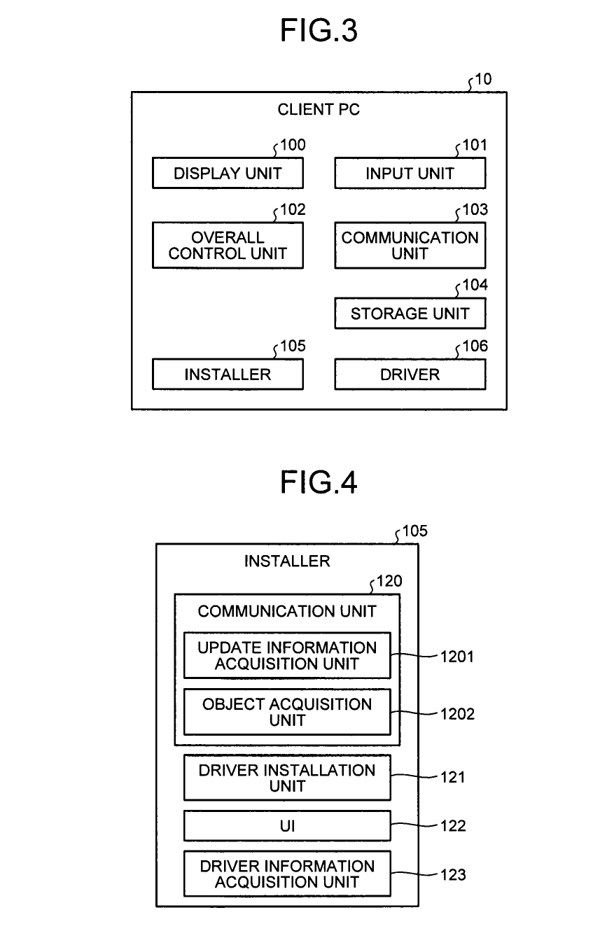

FIG. 3 is an exemplary functional block diagram for explaining functions of the client PC 10 according to the first embodiment. In FIG. 3, the client PC 10 includes a display unit 100, an input unit 101, an overall control unit 102, a communication unit 103, a storing unit 104, an installer 105, and a driver 106.

The overall control unit 102 controls overall operations of the client PC 10 and corresponds to, for example, an operating system (OS) as one of the programs operating on the CPU 51. The display unit 100 displays a screen according to instruction of the overall control unit 102 on the display 56. The input unit 101 transfers information input through the input/output I/F 57 to the overall control unit 102. The communication unit 103 controls communication through the communication I/F 59. The storing unit 104 controls data reading and writing with respect to the RAM 53 or the storage 54.

These components of the display unit 100, the input unit 101, the overall control unit 102, the communication unit 103, and the storing unit 104 consist of a program operating on the CPU 51. It is not limited thereto, and a portion or all of the display unit 100, the input unit 101, the overall control unit 102, the communication unit 103, and the storing unit 104 may consist of pieces of hardware cooperating with each other.

The installer 105 and the driver 106 consist of the program operating on the CPU 51. The driver 106 intermediates between the overall control unit 102 and an external device when the overall control unit 102 controls the external device connected to the client PC 10. In addition, in the case of using the external device through the client PC 10, the driver 106 provides an appropriate user interface (UI) to a user. In this example, the driver 106 is assumed to be a printer driver corresponding to control of, for example, the image forming apparatus 20a (printer #1).

The installer 105 installs the driver 106 in the client PC 10. In addition, the installer 105 performs an updating process for the driver 106 which is previously installed in the client PC 10. For example, the installer 105 determines whether or not the installation-completed driver 106 can be updated, and in the case where it is determined that the driver can be updated, the installer acquires an object for updating the driver 106 through the network 30 and updates the driver 106 by using the acquired object. The installer 105 is provided together with the corresponding driver 106, for example, and installed in the client PC 10 through a predetermined procedure.

FIG. 4 illustrates a configuration of an example of the installer 105 according to the first embodiment. In FIG. 4, the installer 105 includes a communication unit 120, a driver installation unit 121, an UI 122, and a driver information acquisition unit 123.

The communication unit 120 performs communication with the update information server 40 and the object arrangement server 41 and acquires the object for updating the driver 106. The driver installation unit 121 installs the driver in the client PC 10 and updates the driver 106 by using the object acquired by the communication unit 120. The UI 122 provides a user interface such as a display or an input interface to the user at the time of installing or updating the driver 106. The driver information acquisition unit 123 acquires the later-described identification information from the driver 106 which is installed in the client PC 10 (first acquisition unit).

The communication unit 120 includes an update information acquisition unit 1201 and an object acquisition unit 1202. The update information acquisition unit 1201 communicates with the update information server 40 to acquire update information for updating the driver 106 from the update information server 40 (second acquisition unit). At this time, the update information acquisition unit 1201 acquires specification information for specifying the storage location where the update information is stored, based on the identification information acquired from the driver 106 by the driver information acquisition unit 123 and acquires the update information according to the acquired specification information. The update information includes at least information indicating the storage location of the object used for updating the driver 106 in the object arrangement server 41.

The object acquisition unit 1202 acquires the object used for updating the driver 106 from the object arrangement server 41 based on the update information acquired by the update information acquisition unit 1201.

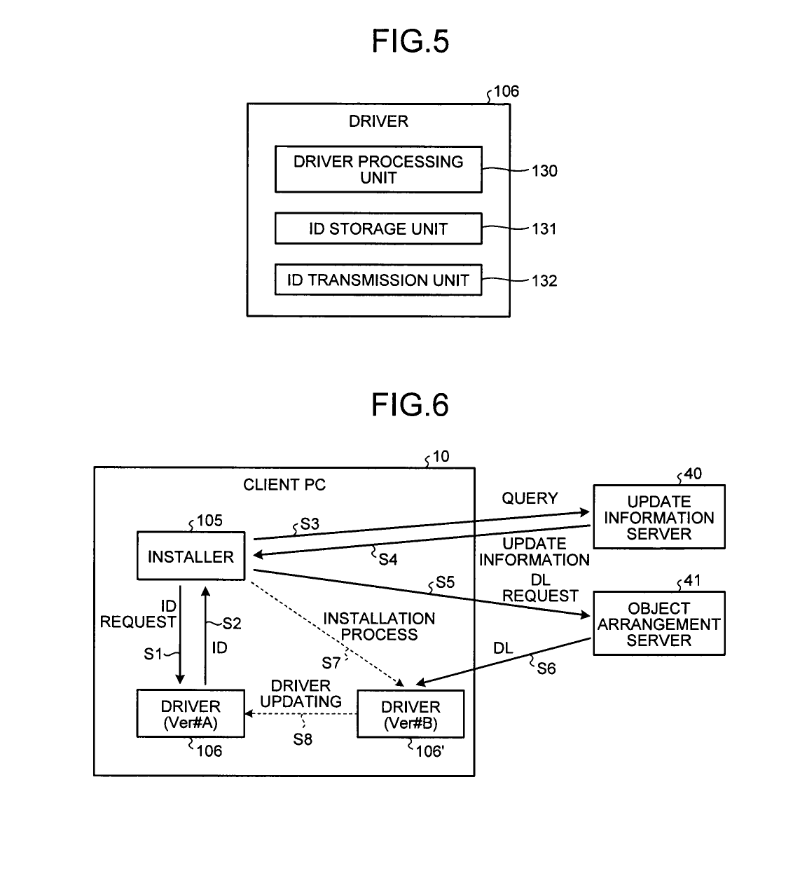

FIG. 5 illustrates a configuration of an example of the driver 106 according to the first embodiment. The driver 106 includes a driver processing unit 130, an ID storage unit 131, and an ID transmission unit 132. The driver processing unit 130 is a portion executing processes as a general driver. As an example, in the case where the driver 106 is a printer driver, the driver processing unit 130 includes a UI unit which provides a user interface prompting the user to perform print setting or peripheral apparatuses setting (printer setting) and a drawing unit which converts actual printing data into a drawing command such as printer control language (PCL) or PostScript.

The ID storage unit 131 stores the identification information unique to the driver 106. Here, “unique to the driver 106” means that the identification information is unique to information group for specifying a driver program capable of updating the driver 106. A specific example of the configuration of the identification information will be described later.

The identification information stored in the ID storage unit 131 is set in advance by a vender of the driver 106. The identification information may be embedded in the program of the driver 106 or may be stored as data separated from the program of the driver 106 in the storage 54 of the client PC 10 in a nonvolatile manner.

In addition, the specification information for specifying the storage location where the update information for updating the driver 106 is stored is configured to include the identification information. As an example, the identification information can be used in a portion, which can specify the driver 106, of uniform resource locator (URL) indicating the storage location where the update information of the driver 106 is stored in the update information server 40.

The ID transmission unit 132 transmits the identification information stored in the ID storage unit 131 to the installer 105 in response to a request from the driver information acquisition unit 123 of the installer 105. The method where the ID transmission unit 132 transmits the identification information to the installer 105 is not particularly limited. For example, the ID transmission unit 132 transmits the identification information to the installer 105 through File, Registry, PrintTicket, PrintCapability, Capability of the driver 106, or the like.

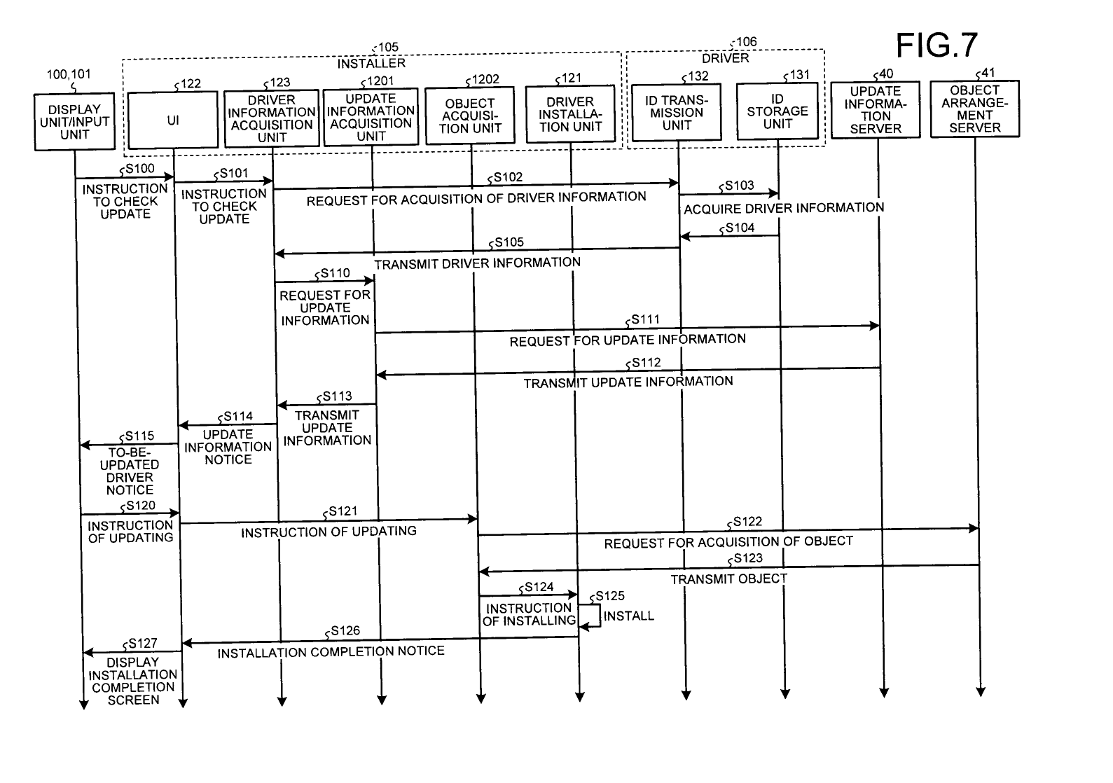

Next, an update procedure of the driver 106 according to the first embodiment will be described in brief with reference to FIG. 6. Incidentally, in FIG. 6, the same components as those of FIGS. 1 and 3 described above are denoted by the same reference numerals, and the description thereof is omitted. In addition, in the description hereinafter, the identification information unique to the driver 106 is appropriately referred to as an “ID”. In FIG. 6, it is assumed that the driver 106 of version Ver#A is installed in advance in the client PC 10.

The update procedure for the driver 106 illustrated in FIG. 6 is started, for example, according to user's manipulation of the client PC 10. If the update procedure is started, the installer 105 first requests the driver 106 to send the ID (step S1). The driver 106 returns the ID to the installer 105 in response to the request (step S2). The installer 105 generates the specification information for specifying the storage location of the update information for updating the driver 106 based on the ID received from the driver 106. The installer 105 queries the update information server 40 about whether or not the update of the driver 106 exists based on the generated specification information (step S3). The update information server 40 returns the update information to the installer 105 in response to the query (step S4).

The installer 105 determines whether or not the update of the driver 106 exists based on the update information received from the update information server 40. In the case where it is determined that the update of the driver 106 exists, the installer 105 requests the object arrangement server 41 to download the object based on information which is included in the update information and indicates the storage location of the object for updating the driver 106 (step S5).

The object arrangement server 41 transmits the object for updating the driver 106 to the client PC 10 in response to the request (step S6). The object is defined as an object constituting the driver 106′ of version Ver#B which is newer than the driver 106 of the version Ver#A. In the client PC 10, the installer 105 stores the object constituting the driver 106′ transmitted from the object arrangement server 41 in a predetermined area of, for example, the storage 54.

The installer 105 performs an installation process on the object transmitted from the object arrangement server 41 (step S7). For example, the installer 105 decompresses the object which is compressed to be stored in a file and is transmitted from the object arrangement server 41 and performs the installation process on the decompressed object. For example, the installer 105 configures the driver 106′ from the object by the installation process and replaces the previously-installed driver 106 with the driver 106′ (step S8). Therefore, the driver 106 is updated to the driver 106′ of a newer version.

In this manner, according to the first embodiment, the update information for updating the installation-completed driver 106 in the client PC 10 is included in the storage location indicated by the specification information based on the identification information which is included in the driver 106 and uniquely identifies the driver 106. Therefore, the installer 105 can execute the acquisition of the object of the driver 106 of an unknown version and the installation based on the identification information of the driver 106.

Next, the update procedure for the driver 106 according to the first embodiment will be described more in detail with reference to a flowchart of FIG. 7. Incidentally, in FIG. 7, the same components as those of FIGS. 1 to 5 described above are denoted by the same reference numerals, and the description thereof is omitted.

For example, in response to user's manipulation on the input unit 101 of the client PC 10, the UI 122 of the installer 105 is instructed to check the update of the driver 106 (step S100). The instruction can be transferred to the driver information acquisition unit 123 through the UI 122 (step S101).

The driver information acquisition unit 123 receives the instruction of the update check and acquires driver information for all the drivers installed in the client PC 10 by the processes of steps S102 to S105. That is, the driver information acquisition unit 123 requests each driver installed in the client PC 10 to send the driver information in step S102.

If the driver whose driver information is requested in step S102 is the driver 106 having the ID according to the first embodiment, the ID transmission unit 132 acquires the ID as the driver information from the ID storage unit 131 in response to the request (steps S103 and S104). Next, the ID transmission unit 132 transmits the acquired ID to the driver information acquisition unit 123 (step S105).

As an example, in the case where the driver information acquisition unit 123 and the ID transmission unit 132 perform ID transfer through a file, it is preferable to predetermine a file name and a storage location of the file for performing the ID transfer between the driver information acquisition unit 123 and the ID transmission unit 132. The ID transmission unit 132 writes the ID in the file, and the driver information acquisition unit 123 reads the ID from the file.

On the other hand, if the driver whose driver information is requested in step S102 is a driver having no ID according to the first embodiment, the ID is not transmitted from the ID transmission unit 132 to the driver information acquisition unit 123. In this case, for example, general driver information is transmitted from the driver to the driver information acquisition unit 123.

The driver information acquisition unit 123 determines the driver from which the ID can be acquired, as a to-be-updated driver as a result of execution of the processes of steps S102 to S105 on all the drivers installed in the client PC 10. Therefore, even in the case where, for example, new and old drivers are mixedly installed in the client PC 10 and a driver from which the ID cannot be acquired exists, the updating of the driver according to the first embodiment can be executed.

The driver information acquisition unit 123 transfers the IDs acquired in the processes of steps S102 to S105 to the update information acquisition unit 1201 and requests the update information acquisition unit 1201 to acquire the update information according to the IDs (step S110). The update information acquisition unit 1201 performs the processes of steps S111 and S112 described later on each of the IDs transferred from the driver information acquisition unit 123 in response to the request and acquires the update information corresponding to each of the IDs, from the update information server 40.

The update information acquisition unit 1201 which receives the ID transferred from the driver 106 in step S110 acquires the specification information which can specify the storage location of the update information corresponding to the ID based on the transferred ID. For example, the update information acquisition unit 1201 generates the specification information based on the ID in accordance with a predefined rule.

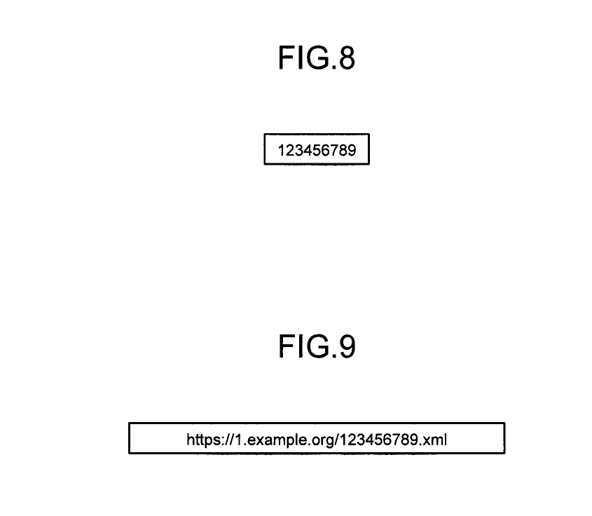

Here, the ID and the specification information will be described by using a specific example. FIG. 8 illustrates an example of the ID according to the first embodiment. In the example of FIG. 8, the ID is illustrated by a character string of a 9-digit number. In this case, as the ID, a serial number using, for example, a 9-digit number is considered to be used. It is not limited thereto, and the ID may be configured by using a character string generated at random. Incidentally, the number of digits of the ID is not limited to 9, but the number of digits may be 10 or more or may be less than 9. In addition, in the case of using a number as the ID, it is not limited to decimal notation, and for example, hexadecimal notation may be used.

FIG. 9 illustrates an example of the specification information according to the first embodiment. In the example of FIG. 9, as the specification information, URL indicating a location of the update information corresponding to the ID on the network is used. In FIG. 9, the specification information indicates that a file having a file name “123456789.xml” in an extensible markup language (xml) format is stored in the location on the network specified by “1.example.org”.

The specification information is configured to include the identification information exemplified in FIG. 9 described above. That is, in the example of FIG. 9, with respect to the file name “123456789.xml” included in the specification information, the character string (in this example, the character string “123456789”) from the front end to the period “.” indicates the identification information. In addition, with respect to the file name, the character string “xml” following the period “.” is extension indicating that the file is in an xml format. In this manner, the specification information is configured in a format including the identification information, so that the driver information acquisition unit 123 can easily generate the specification information from the identification information.

The description returns to step S110 of FIG. 7. The update information acquisition unit 1201 requests the update information server 40 to send the update information in accordance with the specification information (URL) acquired based on the ID transmitted from the ID transmission unit 132 (step S111). The update information server 40 transfers the update information stored in the storage location specified by the specification information to the update information acquisition unit 1201 in response to the request (step S112).

As illustrated in FIG. 9, in the case where the URL including the file name of the update information is used as the specification information, the update information acquisition unit 1201 can directly acquire the file of the update information by accessing the update information server 40 in accordance with the URL.

As described above, the storage location corresponding to the each of the IDs is generated, and the specification information directly indicates the storage location of the update information, that is, the file name of the update information file. Therefore, the update information acquisition unit 1201 can directly acquire the update information file in response to the request for the update information to the update information server 40. This denotes that each file name of the update information file becomes an interface with respect to the request for the update information of the driver 106. For this reason, load on the update information server 40 with respect to the request for the update information can be reduced.

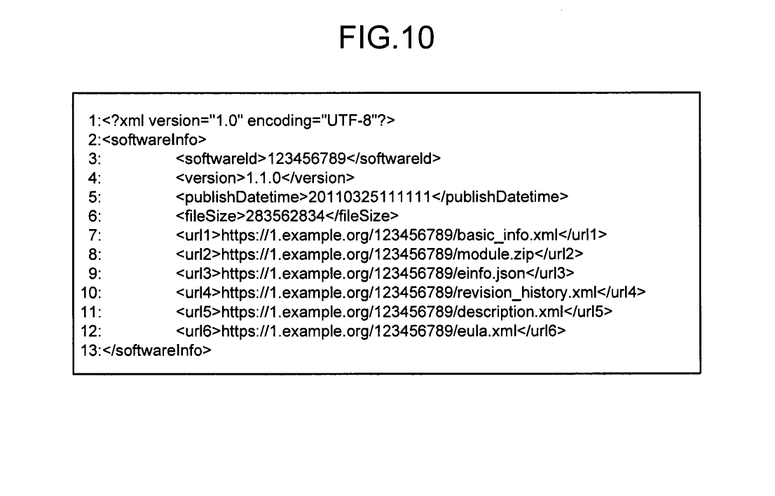

FIG. 10 illustrates an example of the update information according to the first embodiment. Incidentally, in FIG. 10, the number which is written at the front end of each line and delimited from the body of each line by colon (:) is a line number designated for the convenience to explain each line. In addition, the update information illustrated in FIG. 10 is written in the file having the file name included in the URL of FIG. 9 according to the ID of FIG. 8. In FIG. 10, with respect to the update information, the xml written in the file is defined by the description of the first line, and the information used for updating the driver 106 is written in the portion between the tag “<softwareInfo>” of the second line and the tag “</softwareInfo>” of the thirteenth line.

In the third line, the ID corresponding to the update information is written in the portion between the tag “<softwareId>” and the tag “</softwareId>”. In the fourth line, the version of the driver which is to be installed according to the update information is written in the portion between the tag “<version>” and the tag “</version>”. In this example, the value “123456789” corresponding to the file name of the update information is written as the ID, and the version “1.1.0” is written. In the fifth line, the publication date of the driver which is to be installed according to the update information is written in the portion between the tag “<publishDatetime>” and the tag “</publishDatetime>”. In this example, the publication date is written in a format “year, month, day, hour, minute, second”.

In the sixth line, the file size of the object as a main body of the driver which is to be installed according to the update information is written in the portion between the tag “<fileSize>” and the tag “</fileSize>”.

Incidentally, among the descriptions in the third to sixth lines, any one of the descriptions of the fourth and fifth lines and the description of the sixth line may be omitted.

The URL where the object itself is stored as a main body of the driver which is to be installed according to the update information and the URLs where attribute information of the driver is stored are written in the seventh to twelfth lines. In the example of FIG. 10, in the seventh line, the URL of the file storing basic information of the to-be-updated driver is written in the portion between the tag “<url1>” and the tag “</url1>”. Incidentally, the basic information of the driver may include, for example, driver type (a printer driver, a scanner driver, or the like) or an apparatus name corresponding to the driver. In the eighth line, the URL where the object as a main body of the to-be-installed driver is stored is written in the portion between the tag “<url2>” and the “</url2>”. For example, the object is configured with a file compressed in a zip format.

In the ninth to twelfth lines, the URL of the file storing extended information of the driver which is to be installed according to the update information, the URL of the file storing change history, the URL of the file storing detail description, and the URL of the file storing use permission information are written in the portion between the tag “<url3>” and the tag “</url3>”, the portion between the tag “<url4>” and the tag “</url4>”, the portion between the tag “<url5>” and the tag “</url5>”, and the portion between the tag “<url6>” and the tag “</url6>”,respectively.

Incidentally, among the descriptions in the seventh to twelfth lines, the descriptions excluding the description of the URL where the object is stored, in the eighth line may be omitted. In addition, in the example of FIG. 10, the URLs written in the seventh to twelfth lines include the URL of the object arrangement server 41. In addition, the format of the update information is preferably common to the same ID. For example, a common format is applied to the pieces of the update information whose IDs are the same and whose versions or the like are different.

The description is returned to FIG. 7. The update information acquisition unit 1201 transfers the update information acquired in steps S111 and 5112 for each ID to the driver information acquisition unit 123 through, for example, a cache file on the storage 54 (step S113). The driver information acquisition unit 123 notifies the UI 122 of the update information transferred from the update information acquisition unit 1201 (step S114). The UI 122 notifies the display unit 100 of the information indicating the to-be-updated driver based on the update information reported from the driver information acquisition unit 123 (step S115).

Incidentally, the update information acquisition unit 1201 can select the to-be-updated driver among the drivers which are installed in the client PC 10 based on the update information.

For example, the update information acquisition unit 1201 compares the ID (third line of FIG. 10) and the version information (fourth line of FIG. 10) included in the update information with the ID and the version information of, for example, the driver 106 which is previously installed in the client PC 10. As a result of the comparison, in the case where the ID is coincident with the ID of the driver 106 and the version written in the update information is newer than the version of the driver 106, the update information acquisition unit 1201 selects the driver indicated by the update information as a to-be-updated driver. The update information acquisition unit 1201 transfers the update information of the selected to-be-updated driver to the driver information acquisition unit 123.

The method of selecting the to-be-updated driver is not limited to this example. For example, the update information acquisition unit 1201 may compares the publication dates between the update information and the installation-completed driver 106 whose IDs are coincident with each other. In this case, when the publication date written in the update information is newer than the publication date of the installation-completed driver 106, the driver indicated by the update information is selected as the to-be-updated driver. In addition, the update information acquired when the current installed driver 106 is installed is allowed to be cached in, for example, the storage 54 or the like, and by comparing the cached update information with the newly acquired update information, the to-be-updated driver may be selected based on a difference between the two update information.

Incidentally, it is not limited to the example where the to-be-updated driver is selected at the installer 105 side, and the to-be-updated driver may be selected at the update information server 40 side. In this case, the installer 105 transmits the ID and the version information of the installation-completed driver in the client PC 10 to the update information server 40. The update information server 40 searches for the update information of the driver whose ID is coincident and whose version is newer based on the ID and the version information and transmits the update information to the installer 105.

Incidentally, the information on the version or the publication date of the installation-completed driver 106 can be acquired directly from the driver 106. It is not limited thereto, and the update information when the driver 106 is installed may be stored in a file or a registry.

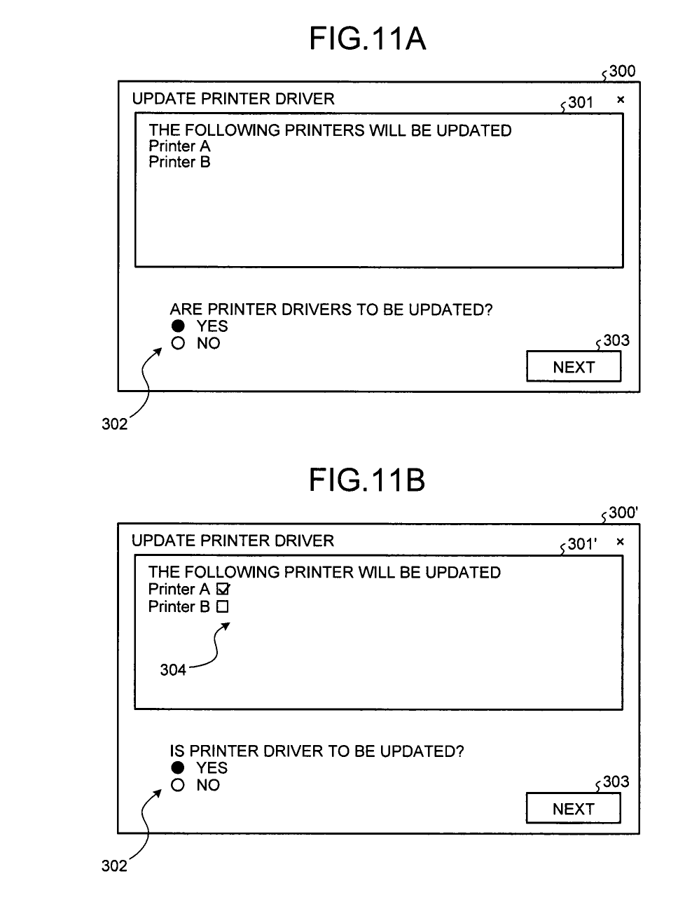

The display unit 100 displays a display screen illustrating the to-be-updated driver on the display 56 based on the information reported from the UI 122. FIGS. 11A and 11B illustrate an example of the display screen displayed by the display unit 100 according to the first embodiment. In the example of FIG. 11A, the display screen 300 displays printer names corresponding to the to-be-updated drivers as a list in an area 301. The installer 105 acquires the information indicating the printer name from the driver having the ID which is coincident with the ID included in the update information reported from the UI 122, for example, among the drivers which are previously installed in the client PC 10 and displays the printer name based on the acquired information.

In the display screen 300, in response to manipulation on the input unit 101, a selection input unit 302 selects whether the driver displayed in the area 301 is to be updated. In the example of FIG. 11A, “Yes” is selected in the selection input unit 302, and a button 303 is manipulated, so that the updating of the driver displayed in the area 301 is started.

The display screen 300 is not limited to the example of FIG. 11A. FIG. 11B illustrates an example of a display screen 300′ which allows the to-be-updated driver to be selectable. In the display screen 300′, with respect to the list of the to-be-updated drivers displayed in the area 301′, check boxes 304 are added to the printer names. In this case, the updating process is selectively executed on the driver whose check box 304 is checked by manipulation on the input unit 101.

The description is returned to FIG. 7. If driver updating manipulation is performed on the display screen 300, the UI 122 is notified of that fact from the input unit 101 (step S120). The UI 122 transfers the update information of the to-be-updated driver to the object acquisition unit 1202 and instructs the object acquisition unit 1202 to perform driver updating (step S121).

The object acquisition unit 1202 transmits a request for object acquisition to the object arrangement server 41 based on the update information transferred from the UI 122 (step S122). The object arrangement server 41 transmits the object in response to the request. The object transmitted from the object arrangement server 41 is acquired by the object acquisition unit 1202 (step S123). In the case where a plurality of the update information is transferred from the UI 122, the object acquisition unit 1202 transmits the request for acquisition of the plurality of the update information and acquires the objects according to the plurality of the update information.

More specifically, the object acquisition unit 1202 accesses the object arrangement server 41 to acquire the object from the URL in accordance with the description (eighth line of FIG. 10) of the URL which is included in the update information transferred from the UI 122 and stores the object as a main body of the to-be-installed driver.

The object acquisition unit 1202 temporarily stores the object acquired from the object arrangement server 41, for example, in the storage 54 in association with the ID included in the update information.

The object acquisition unit 1202 instructs the driver installation unit 121 to install the object acquired from the object arrangement server 41 (step S124). The driver installation unit 121 starts the installation process for the object acquired from the object arrangement server 41 in response to the instruction (step S125). In the case where the object is configured as a compressed file, the driver installation unit 121 decompresses the compressed file and executes the installation process. In the case where the object acquisition unit 1202 acquires a plurality of the update information, the driver installation unit 121 executes the installation process for the objects corresponding to the plurality of the update information based on the IDs associated with the objects.

If the installation process for all the object is completed, the driver installation unit 121 notifies the UI 122 of that fact (step S126). The UI 122 instructs the display unit 100 to display an installation completion screen indicating that the driver installation is completed (step S127). The display unit 100 displays that the installation is completed on the display 56 according to the instruction.

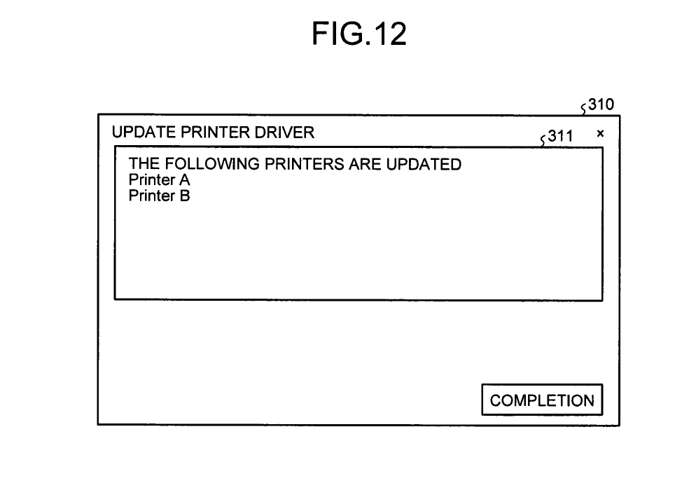

FIG. 12 illustrates an example of the installation completion screen which the display unit 100 displays on the display 56 according to the first embodiment. In FIG. 12, the installation completion screen 310 displays a list of the drivers which are installed and updated in the area 311 (in this case, printer names corresponding to the drivers).

In this manner, according to the first embodiment, the installer 105 is configured so as to acquire the update information including the URL of the object used for updating the driver 106 according to the specification information (for example, URL) based on the identification information (ID) included in the driver 106 which is to be installed in the client PC 10. Therefore, even in the case where the update information stored in the storage location specified by the specification information based on the identification information included in the driver 106 is update information of an unknown driver at the time of installing the driver 106, the installer 105 can install the unknown driver in the client PC 10.

Here, an example of the ID applicable to the first embodiment will be described. As described above, the ID takes a value unique to the information group for specifying the driver program which can update the driver 106 identified by the ID.

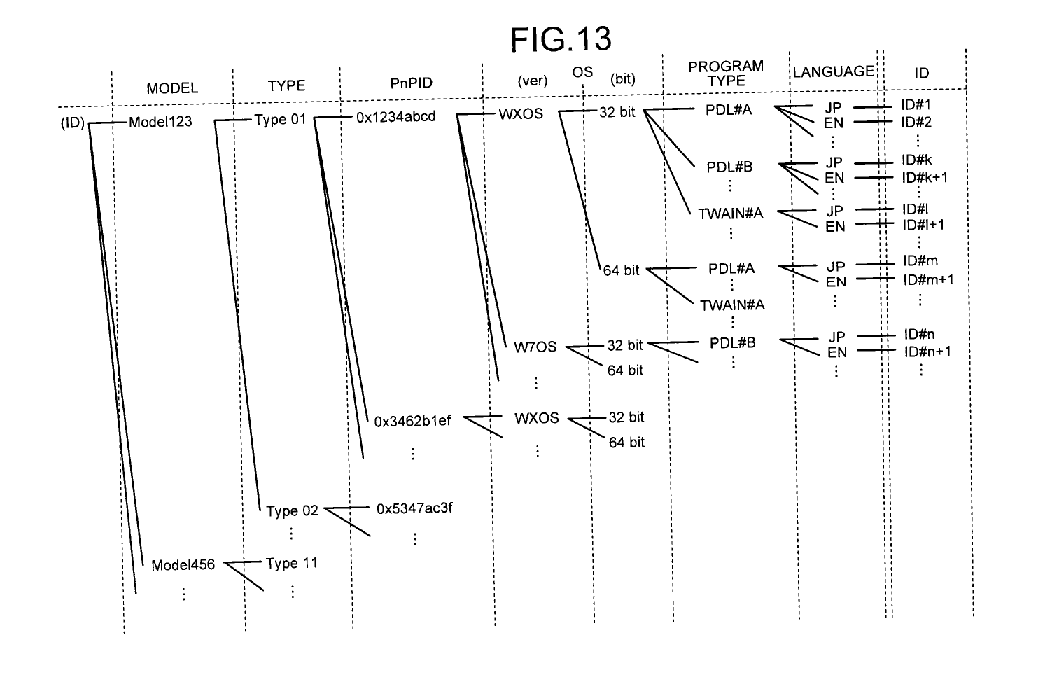

Examples of the IDs according to the embodiments will be described with reference to FIG. 13. In FIG. 13, as the examples of the information included in the information group for specifying the driver program which can update the driver 106, illustrated are information of items “Model”, “Type”, “PnPID”, “operating system (OS)”, “Program Type”, and “Language”. In addition, in the example of FIG. 13, the information is configured hierarchically so that the left-side item is in a higher level and the right-side item is in a lower level and the information is associated with each other by a tree structure having the information as nodes.

Among the items illustrated in FIG. 13, the item “Model” and the item “Type” indicate information for specifying hardware which is to be controlled by the driver 106. In the example of FIG. 13, one model “Model123” in the item “Model” are associated with a plurality of types “Type01”, “Type02”, . . . .

The item “PnPID” indicates PnPID which is in correspondence with the hardware. In the example of FIG. 13, the information specified by the model “Model123” and the type “Type01” is associated with a plurality of the PnPIDs “0x1234abcd”, “0x3462b1ef”, . . . .

The item “OS” indicates an OS corresponding to the driver 106. In the example of FIG. 13, the item “OS” includes an item “Version (ver)” and a lower-level item “Operation Bit” of the item “Version”, and each version includes the operation bit “32bit” and the operation bit “64bit”. In the example of FIG. 13, the information specified by the model “Model123”, the type “Type01”, and the PnPID “0x1234abcd” is associated with a plurality of OSs “WXOS”, “W7OS”, . . . .

The item “Program Type” indicates a function of the driver 106. For example, the item “Program Type” indicates which one of the printer and scanner functions is to be controlled by the driver 106. In addition, the item “Program Type” may further indicates which one of detailed functions of the printer or scanner function corresponds to the driver 106. As an example, the item “Program Type” may indicate a type of the page description language (PDL) corresponding to the printer function.

In FIG. 13, the lowest-level item “Language” indicates a language (JP, EN, . . . ) applied to the function indicated by the higher-level item “Program Type”.

In such a configuration, in each embodiment, IDs are uniquely associated with leaf nodes in the tree structure. Therefore, the information group including the information by the nodes which are sequentially traced from the leaf nodes to the parent node is uniquely associated with the ID.

In the example of FIG. 13, the information group including the model “Model 123”, the type “Type01”, the PnPID “0x1234abcd”, the OS version “WXOS”, the OS operation bit “32bit”, the program type “PDL#A”, and the language “JP” is uniquely associated with the ID “ID#1”. In addition, for example, the information group including the model “Model123”, the type “Type01”, the PnPID “0x1234abcd”, the OS version “WXOS”, the OS operation bit “32bit”, the program type “TWAIN#A”, and the language “EN” is uniquely associated with the ID “ID#1+1”. Furthermore, for example, the information group including the model “Model123”, the type “Type01”, the PnPID “0x1234abcd”, the OS version “W7OS”, the OS operation bit “32bit”, the program type “PDL#B”, and the language “JP” is uniquely associated with the ID “ID#n”.

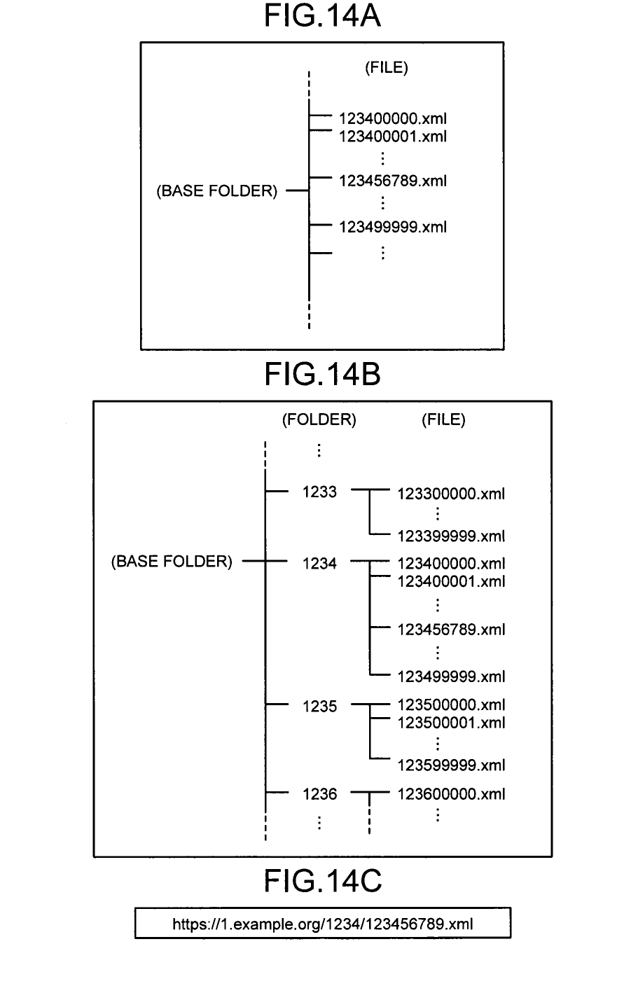

FIGS. 14A to 14C illustrate an example of a management method for the update information applicable to each embodiment. In each embodiment, all the files of the update information indicated by the specification information are stored under the base folder in the update information server 40 as illustrated in FIG. 14A. Incidentally, the base folder is assumed to correspond to, for example, URL “https://1.example.org/”.

The management method for the update information is not limited to the example of FIG. 14A. For example, as illustrated in FIG. 14B, in the update information server 40, the update information may be controlled so that the update information file indicated by the specification information is divided to be stored in a plurality of folders. As described above, the specification information is set to correspond to the ID, and the ID is uniquely set to the information group including the information of the plurality of the items. Therefore, it is predicted that the number of update information files indicated by the specification information becomes large. In this manner, the files of the update information are distributed to be stored in the plurality of the folders, so that the update information can be easily managed.

As the folder name of each folder, a character string common to the file names of the files stored in the folder is considered to be used. For example, with respect to the update information files, the files having common m characters (m<n) out of a character string (excluding the period and the extension) of n characters constituting the file names are collected from the front end and are stored in the folder with the folder name being a character string of the m characters. In the example of FIG. 14A, the files having common four digits from the front end of the file name (excluding the period and the extension) configured with a character string of a 9-digit number are stored in the folder whose folder name is the character string of a number of four digits from the front end. In the case of the management method of FIG. 14B, the specification information for specifying the update information becomes the information including the file name and the folder name as exemplarily illustrated in FIG. 14C.

Incidentally, in the above description, although it is described that the specification information directly indicates the file name of the update information file and the interfaces for the query to the update information server 40 as many as the number of update information files are provided, it is not limited to this example. For example, the update information server 40 may be configured to have a tree structure of the IDs described in FIG. 13 as a table and to search for the ID based on the information corresponding to each node of the tree structure.

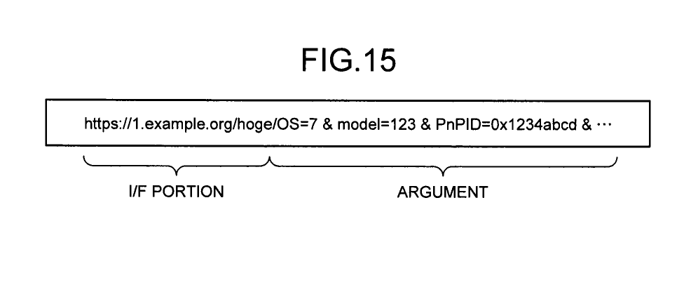

In this case, the installer 105 transfers, for example, the information corresponding to each node of the tree structure as an argument to the update information server 40, and the update information server 40 searches for the ID by referring to the table based on the argument. FIG. 15 illustrates an example of the specification information in this case. In FIG. 15, the portion “https://1.example.org/hoge/” is an interface (I/F) portion, and the portion after “/hoge/” is an argument portion. That is, the installer 105 accesses the update information server 40 by using the portion “https://1.example.org/hoge/” as a common interface and transfers the argument portion to the update information server 40 to perform query. Incidentally, a value according to the value of the purpose of the query is used for the portion “/hoge/”.

In the case of the configuration illustrated in FIG. 15, the update information server 40 performs searching based on the arguments included in the specification information. On the other hand, in the example illustrated in FIGS. 14A and 14B described above where the ID are provided to each specification information, the ID can be directly acquired by using the specification information. Therefore, in comparison with the configuration illustrated in FIGS. 14A and 14B, in the configuration illustrated in FIG. 15, the load to the database is considered to be increased.

More specifically, in the first embodiment, as described with reference to FIG. 13, since the ID is uniquely in correspondence to each leaf node of the tree structure, if the number of layers of the nodes is increased, it is predicted that the number of IDs, that is, the number of types of the drivers becomes large. In the case where such a large number of IDs are searched from the update information server 40, the update information server 40 preferably has a configuration where each ID has an interface as illustrated in FIGS. 14A and 14B described above so as for the load to be decreased in comparison with the configuration where the IDs has a common interface as described with reference to FIG. 15.

For example, when the driver 106 is to be installed in the client PC 10, the installer 105 needs to determine an appropriate driver program according to a to-be-controlled driver 106 or operation environment (OS version or the like) of the driver 106. In this case, the method of searching for the ID by referring to the table based on the argument is appropriate.

### Modified Example of First Embodiment

Next, a modified example of the first embodiment will be described. In the above-described first embodiment, the installer 105 (driver information acquisition unit 123) acquires the information of the driver 106 used for checking the update of the driver 106 from the driver 106 (ID storage unit 131). In contrast, in the modified example of the first embodiment, the installer 105 acquires the information of the driver used for checking the update of the driver 106 from a predetermined storage area in the client PC 10.

In the modified example of the first embodiment, the installer 105 stores the driver information of the driver 106 whose installation is performed in a predetermined storage area in the storage 54 included in the client PC 10 when the driver 106 is installed in the client PC 10. For example, a management area managed by the OS of the client PC 10 may be used as the predetermined storage area in which the installer 105 stores the driver information. If the OS is Windows (registered trade mark), a registry can be applied to the OS management area. Access to the OS management area is performed through the OS. It is not limited thereto, and a predetermined folder is created in the storage 54 of the client PC 10, the driver information may be stored in the folder.

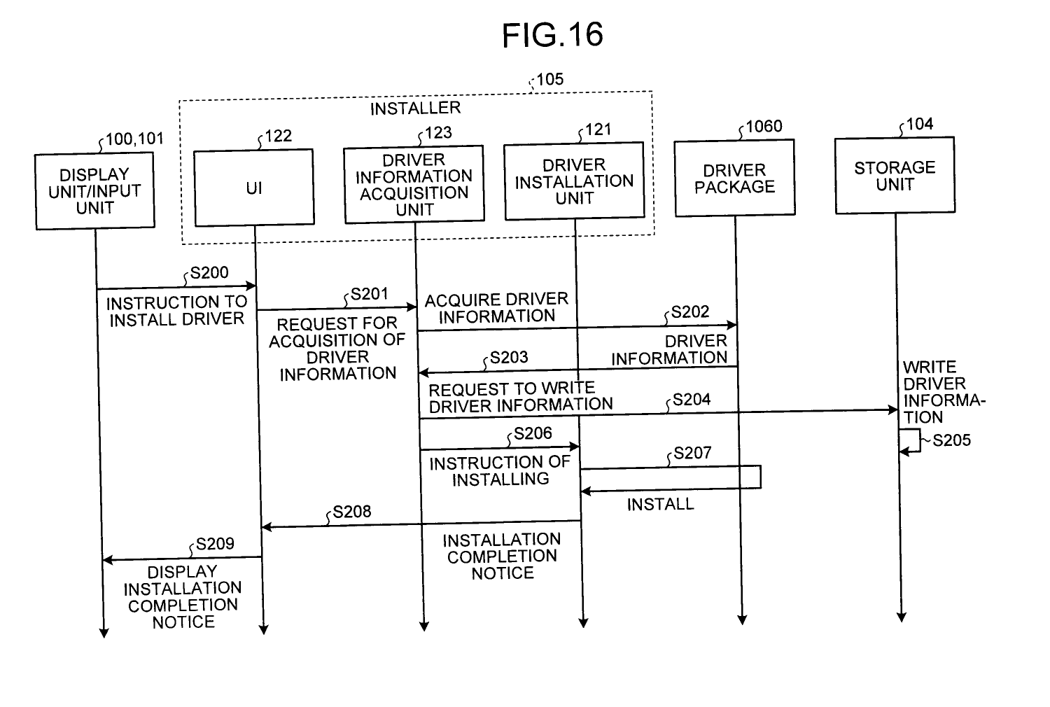

FIG. 16 is a flowchart illustrating an example of the installation procedure for the driver 106 according to the modified example of the first embodiment. Incidentally, in FIG. 16, the same components as those of FIGS. 1 to 4 described above are denoted by the same reference numerals, and the description thereof is omitted.

In FIG. 16, the driver package 1060 is a file storing the data for installing the driver 106. The driver package 1060 stores, for example, a program file (object) of the driver 106 and a file where the driver information used for installing the driver 106 is written. The driver information includes, for example, the ID of the driver 106 which is to be installed by the driver package 1060 and the name designated to the driver 106.

The installer 105 fetches the files from the driver package 1060 and performs installation of the driver 106. The client PC 10 may acquire the driver package 1060 from the server or the like via the network 30 or may acquire the driver package from a recording medium such as a compact disk (CD) or a digital versatile disk (DVD) on which the driver package 1060 is recorded.

It is assumed that, before the process of FIG. 16, the client PC 10 acquires the driver package 1060 and stores the driver package in the storage 54. For example, according to user's manipulation on the input unit 101 of the client PC 10, the UI 122 of the installer 105 is instructed to install the driver 106 (step S200). The UI 122 transfers the instruction to the driver information acquisition unit 123 and requests the driver information acquisition unit 123 to acquire the driver information (step S201).

In response to the request for acquisition of the driver information from the UI 122, the driver information acquisition unit 123 acquires the driver information from the driver package 1060 (step S202, step S203). The driver information acquisition unit 123 transfers the acquired driver information to the storing unit 104 and requests the storing unit 104 to write the transferred driver information (step S204). In response to the request, the storing unit 104 writes the driver information transferred from the driver information acquisition unit 123 in the management area (for example, a registry) of the OS (step S205). For example, the storing unit 104 requests the OS of the client PC 10 to write the driver information in the OS management area.

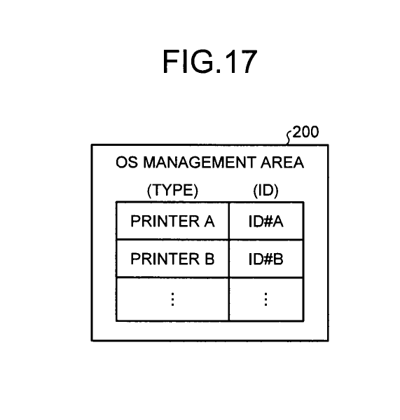

FIG. 17 illustrates an example of the driver information written in the OS management area 200 according to the modified example of the first embodiment. In this example, the ID of the driver 106 included in the driver information is written in the OS management area 200 in association with, for example, the information (in this example, “printer A” and “printer B”) indicating the type of the driver 106. Other information included in the driver information may be further written in the OS management area 200 to be associated with the ID. Incidentally, the driver information of a driver other than the driver, which the installer 105 can cope with, may be written in the OS management area 200.

After the request for writing the driver information in step S204, the driver information acquisition unit 123 instructs the driver installation unit 121 to install the driver (step S206). The driver installation unit 121 fetches the files from the driver package 1060 and performs the installation process for the driver 106 (step S207). When the installation process for the driver 106 is completed, the driver installation unit 121 notifies the UI 122 of that fact (step S208). The UI 122 instructs the display unit 100 to display the installation completion notice (step S209). The display unit 100 displays the massage indicating that the installation is completed on the display 56 according to the instruction.

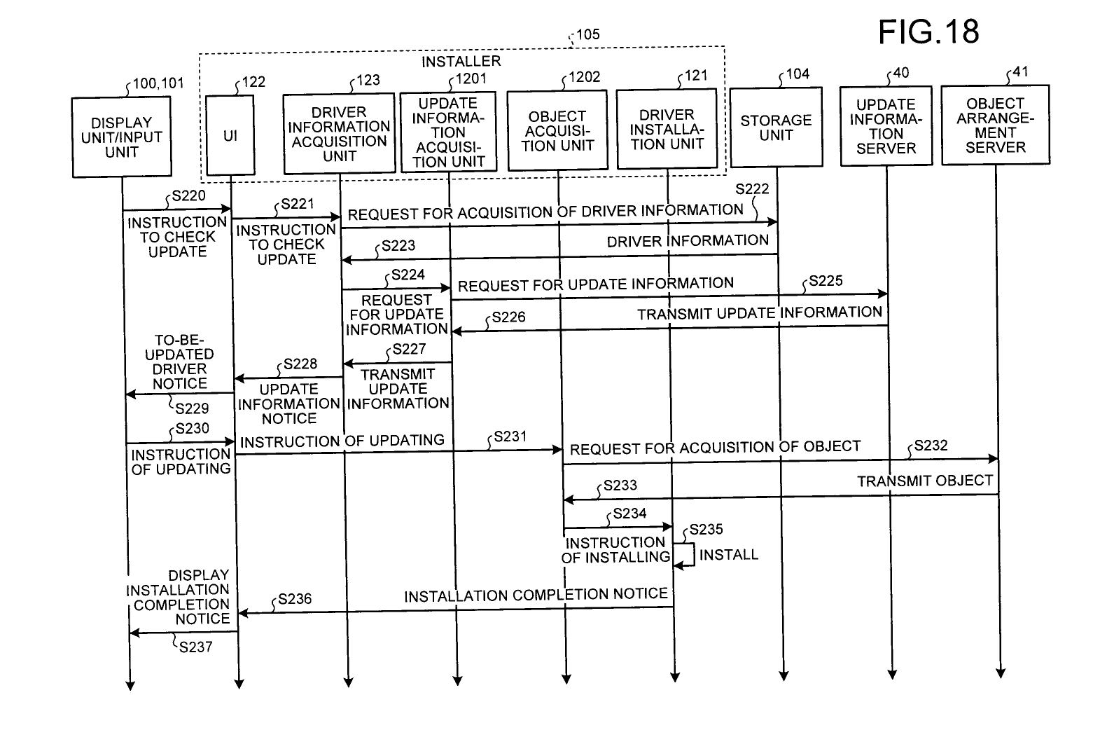

FIG. 18 is a flowchart illustrating an example of the update procedure for the driver 106 according to the modified example of the first embodiment. Incidentally, in FIG. 18, the same components as those of FIGS. 1 to 4 described above are denoted by the same reference numerals, and the description thereof is omitted.

For example, in response to user's manipulation on the input unit 101 of the client PC 10, the UI 122 of the installer 105 is instructed to check the update of the driver 106 (step S220). The instruction can be transferred from the UI 122 to the driver information acquisition unit 123 (step S221).

The driver information acquisition unit 123 receives the instruction of the update check and requests the storing unit 104 to acquire the driver information (step S222). In response to the request, the storing unit 104 acquires from the OS management area 200 all of the driver information where the ID and the information indicating the type of the driver are written in association with each other. The storing unit 104 transfers the acquired driver information to the driver information acquisition unit 123 (step S223).

The driver information acquisition unit 123 selects the driver information of the driver 106, which the installer 105 can cope with, from the driver information transferred from the storing unit 104. For example, the driver information acquisition unit 123 determines based on the ID included in the driver information whether or not the driver information is the driver 106 which the installer 105 can cope with. The determination is performed, for example, by determining whether or not the ID in accordance with the above-described predetermined format can be acquired from the driver information.

The following processes are substantially the same as the above-described processes after step S110 of FIG. 7. For example, the driver information acquisition unit 123 transfers the IDs acquired in the processes of steps S222 and S223 to the update information acquisition unit 1201 and requests the update information acquisition unit 1201 to acquire the update information according to the IDs (step S224). The update information acquisition unit 1201 generates the above-described specification information based on the IDs transferred from the driver information acquisition unit 123. The update information acquisition unit 1201 requests the update information server 40 to send the update information according to the generated specification information (step S225) and acquires the update information transmitted from the update information server 40 in response to the request (step S226).

The update information acquired with respect to the IDs is transferred from the update information acquisition unit 1201 through the driver information acquisition unit 123 to the UI 122 (step S227, step S228). Incidentally, even in this case, the update information acquisition unit 1201 can select the to-be-updated driver based on the update information among the drivers which are installed in the client PC 10. The UI 122 notifies the display unit 100 of the information indicating the to-be-updated driver based on the transferred update information (step S229).

The display unit 100 displays the display screen 300 (refer to FIG. 11A) illustrating the to-be-updated driver on the display 56 based on the information reported from the UI 122. At this time, as illustrated in FIG. 11B, the display unit 100 may display the display screen 300′ where the to-be-updated driver can be selected.

The UI 122 is notified of the driver updating manipulation on the display screen 300 from the input unit 101 (step S230). The UI 122 transfers the update information of the to-be-updated driver to the object acquisition unit 1202 and instructs the object acquisition unit 1202 to update the driver (step S231).

The object acquisition unit 1202 transmits a request for object acquisition to the object arrangement server 41 based on the update information transferred from the UI 122 (step S232) and acquires the object transmitted from the object arrangement server 41 in response to the request (step S233).

The object acquisition unit 1202 instructs the driver installation unit 121 to install the acquired object (step S234). In response to the instruction, the driver installation unit 121 executes the installation process for the object acquired from the object arrangement server 41 (step S235). If the installation process is completed, the driver installation unit notifies the UI 122 of that fact (step S236). In response to the notice, the UI 122 instructs the display unit 100 to display an installation completion screen indicating that the driver installation is completed (step S237). The display unit 100 displays an installation completion screen 310 (refer to FIG. 12) indicating that the installation is completed on the display 56 according to the instruction.

### Second Embodiment

Next, a second embodiment will be described. In the above-described first embodiment, although it is described that one type of the driver 106 is installed in the client PC 10, in fact, in many cases, a plurality of types of the drivers are installed in the client PC 10. Here, it is assumed that the types of the drivers correspond to the methods of installing the drivers in client PC 10. For example, since the printer apparatus and the scanner apparatus have different driver structures, the installation methods are also different.

In addition, an application program is also installed in the client PC 10. In some cases, the application program is installed in addition to the driver, and in other cases, the application program may installed alone. Incidentally, a relatively narrow range of work is assumed, and the application program is a program produced in proximity to user's specific request. In general, direct control of an external apparatus such as a printer or a scanner on the client PC 10 is not performed. The installation method for the application program is different from the installation method for each of the drivers.

In the second embodiment, in the case where a plurality of types of the drivers and the application program whose installation methods are different are to be installed in the client PC 10, the updating method for the programs (driver program and application program) will be described.

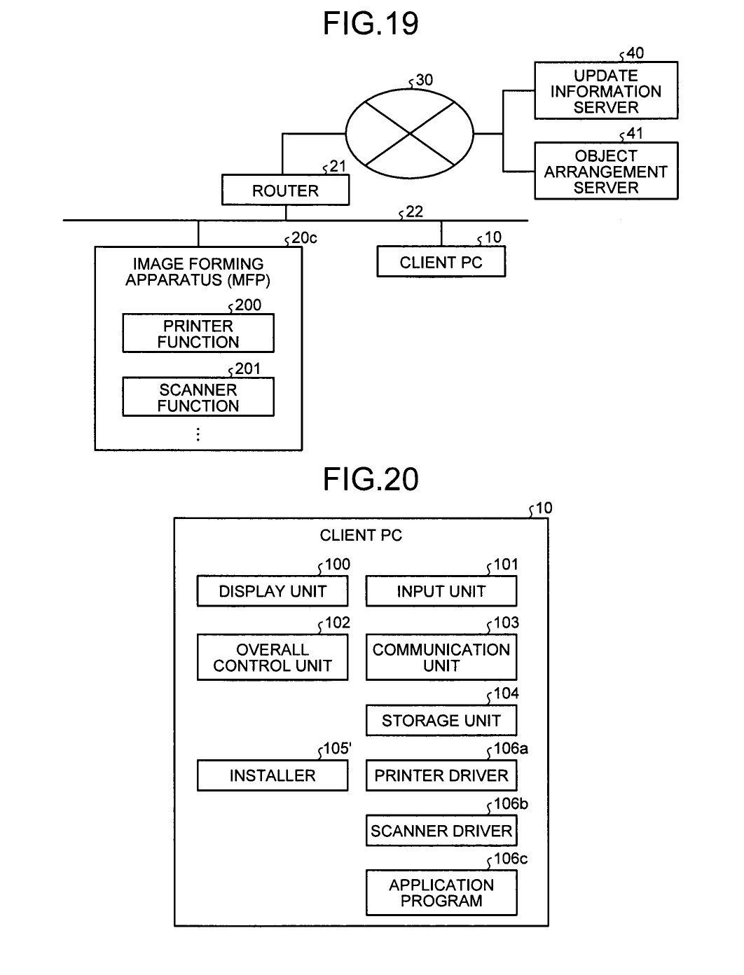

FIG. 19 illustrates an example of an information processing system applicable to the second embodiment. Incidentally, in FIG. 19, the same components as those of FIG. 1 described above are denoted by the same reference numerals, and the description thereof is omitted.

In FIG. 19, as an image forming apparatus 20c, a multi function printer (MFP) having a plurality of functions including a printer function 200 and a scanner function 201 is connected to the network 22. The client PC 10 may communicate with the image forming apparatus 20c via the network 22 to allow the image forming apparatus 20c to execute printing by using the printer function 200 or to acquire image data by reading an original by using the scanner function 201. In addition, the client PC 10 may execute various data processes such as generating or editing of print data for performing printing by using the printer function 200 or processing of the image data acquired by using the scanner function 201.

FIG. 20 is an exemplary functional block diagram for explaining the functions of the client PC 10 according to the second embodiment. Incidentally, in FIG. 20, the same components as those of FIG. 3 described above are denoted by the same reference numerals, and the description thereof is omitted. In addition, since the configuration described with reference to FIG. 2 in the first embodiment may be applied without modification to the hardware configuration of the client PC 10 according to the second embodiment, the description of the hardware configuration is omitted here.

In FIG. 20, the client PC 10 includes a printer driver 106a for controlling the printer function 200 and a scanner driver 106b for controlling the scanner function 201 as the drivers.

In addition, the client PC 10 may include an application program 106c. The application program 106c applies a predetermined data process to data. For example, the application program 106c generates the print data by applying a process to the data and transfers the generated print data to the printer driver 106a. The printer driver 106a controls the printer function 200 according to the print data transferred from the application program 106c. In addition, for example, the application program 106c may instruct the scanner driver 106b to control the scanner function 201 to acquire the image data and may perform an image process on the acquired image data. The functions of the application program 106c are not limited thereto.

The installer 105′ is configured so as to install the printer driver 106a, the scanner driver 106b, and the application program 106c for which the installation methods are different.

Here, the installation process and the updating process which are executed by the installer 105′ will be described in brief. Incidentally, hereinafter, if there is no particular description, the installation process and the updating process are representatively referred as the installation process.

The installation process is executed by the OS through a predefined procedure according to the type of the to-be-installed program. Therefore, there is a need for preparing installers dedicated to the types of the programs. For example, the driver program and the application program are different from each other in terms of the installation method. In addition, the printer driver and the scanner driver which are driver programs whose to-be-controlled apparatus types are different are different from each other in terms of the installation methods determined by the OS. Therefore, dedicated installers for the application program, the printer driver, and the scanner driver are prepared.

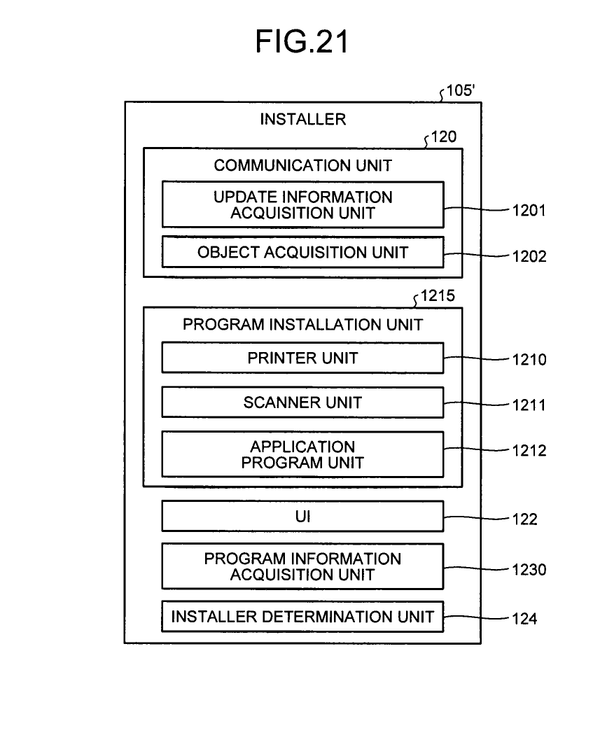

FIG. 21 illustrates a configuration of an example of the installer 105′ according to the second embodiment. Incidentally, in FIG. 21, the same components as those of FIG. 4 described above are denoted by the same reference numerals, and the description thereof is omitted. In FIG. 21, the installer 105′ includes a communication unit 120, a program installation unit 1215, a UI 122, a program information acquisition unit 1230, and an installer determination unit 124. In addition, the program installation unit 1215 includes a printer unit 1210, a scanner unit 1211, and an application program unit 1212 for executing installation according to the program type. The printer unit 1210 executes installation of the printer driver 106a. The scanner unit 1211 executes installation of the scanner driver 106b. In addition, the application program unit 1212 executes installation of the application program 106c.

The program information acquisition unit 1230 acquires program information from the installation package which is installed in the client PC 10. The program information includes at least the identification information (ID) of the program corresponding to the above-described driver information. The program information may further include information indicating the type of the program. The installer determination unit 124 determines which one of the printer unit 1210, the scanner unit 1211, and the application program unit 1212 included in the program installation unit 1215 is to be used when the program is installed.

In response to the instruction of the program installation, the installer 105′ acquires the program information and metadata from the installation package storing the to-be-installed program and produces a list of programs that can be installed. The installer 105′ executes the installation process according to the program type of the to-be-installed program.

More specifically, the installer 105′ allows the installer determination unit 124 to determine the program type of the to-be-installed program based on the acquired program information. Next, in response to a result of the determination of the installer determination unit 124, the installer 105′ selects one from the printer unit 1210, the scanner unit 1211, and the application program unit 1212 included in the program installation unit 1215, according to the program type of the to-be-installed program and executes the installation process.

The installation processes by the printer unit 1210, the scanner unit 1211, and the application program unit 1212 will be described in brief.

The printer unit 1210 executes installation of the of the printer driver with respect to the client PC 10. The installation process for the printer driver which is to be executed by the printer unit 1210 includes a process of storing files constituting the printer driver in a folder defined by the OS on the client PC 10, a process of setting a print port, a process of producing a logic printer queue, and a process of initial setting of registry in the case where the OS is Windows (registered trade mark). Incidentally, the process of producing the logic printer queue includes, for example, a process of producing an icon indicating a printer corresponding to the to-be-installed printer driver.

The scanner unit 1211 executes installation of the scanner driver with respect to the client PC 10. The installation process for the scanner driver which is to be executed by the scanner unit 1211 includes a process of storing files constituting the scanner driver in a folder defined by the OS on the client PC 10 and a process of setting a scan port.

The application program unit 1212 executes installation of the application program. The installation process for the application program which is to be executed by the application program unit 1212 includes a process of storing files constituting the application program in a predetermined folder created on the client PC 10 and processes of initial setting of registry and registering a start menu in the case where the OS is Windows (registered trade mark).

Incidentally, a folder prepared by the OS (folder “Program Files” in the case where the OS is Windows (registered trade mark) may be used as the folder storing the files constituting the application program. It is not limited thereto, and the file constituting the application program may be stored in an arbitrary folder created in the client PC 10.

As the application program which the installer 105′ can cope with, a projection application, an electronic blackboard viewer, an MFP control application, and the like are considered. Among these application programs, the projection application is an application program for performing projection of a display screen of the client PC 10 on a projector apparatus or setting of the projector apparatus by the client PC 10. In addition, the electronic blackboard viewer is an application program for performing viewing of generated images or the like in the client PC 10 by the user performing manipulation on an electronic blackboard capable of drawing by using a touch panel or setting of the electronic blackboard by the client PC 10. In addition, the MFP control application is an application program for performing manipulation of the image forming apparatus such as an MFP on the client PC 10.

In addition, as the application program which the installer 105′ can cope with, an application program for using a cloud storage or a setting tool for performing setting of radio communication such as WiFi (registered trade mark) of an image forming apparatus such as an MFP or an apparatus such as a projector apparatus is considered.

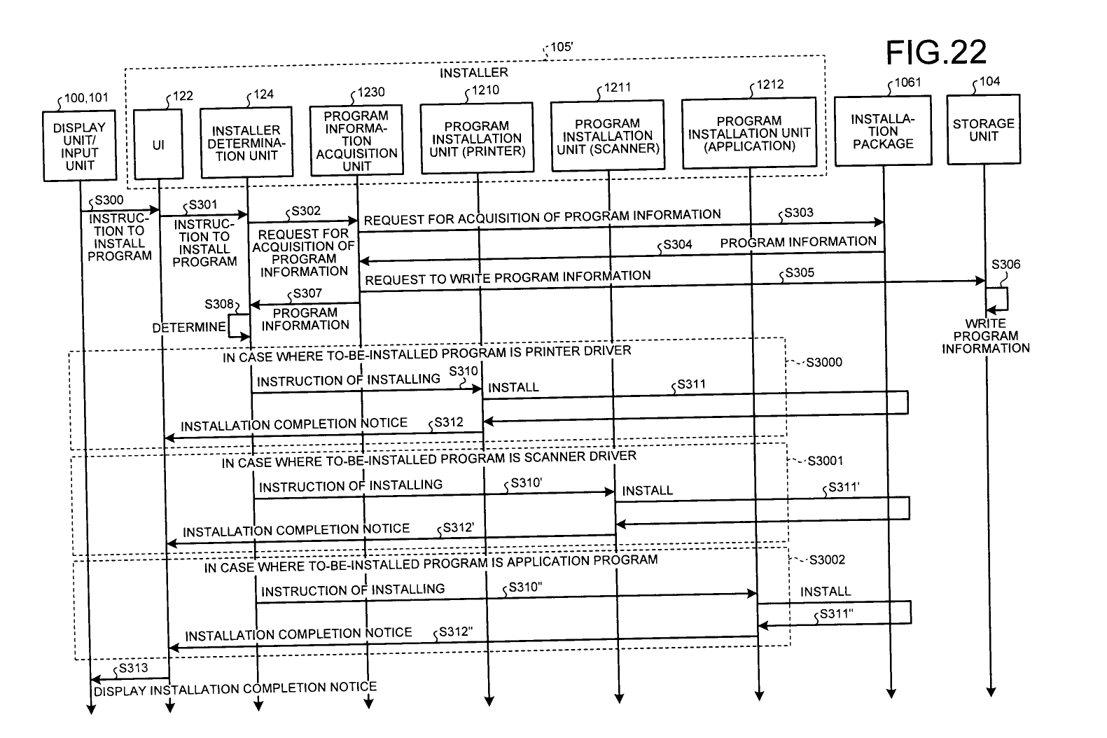

FIG. 22 is a flowchart illustrating an example of an installation procedure for the printer driver 106a, the scanner driver 106b, and the application program 106c according to the second embodiment. Incidentally, in FIG. 22, the same components as those of FIGS. 1, 2, 20, and 21 described above are denoted by the same reference numerals, and the description thereof is omitted. Hereinafter, appropriately, the printer driver 106a, the scanner driver 106b, and the application program 106c are representatively referred to as a “program”.

In FIG. 22, an installation package 1061 is a file storing data for installing the program and stores files (objects) constituting the program and a file in which the program information used for installing the program is written. As an example of the installation package 1061, there is a driver package storing the printer driver 106a or the scanner driver 106b or an application package storing the application program 106c.

The program information includes, for example, the ID of the program which is to be installed by the installation package 1061, the name designated to the program, and class information of the program. The class information is, for example, type information indicating the type of the program. In the case where the program is a driver program such as the printer driver 106a or the scanner driver 106b, the class information can be used to identify the to-be-controlled program. As an example which is more specific than this case, the class information indicates which one of the printer and the scanner the driver is to control.

It is assumed that, before the process of FIG. 22, the client PC 10 acquires the installation package 1061 through the network 30 or through a recording medium such as a CD or a DVD and stores the installation package in the storage 54. For example, according to user's manipulation on the input unit 101 of the client PC 10, the UI 122 of the installer 105′ is instructed to install the program (step S300). The UI 122 transfers the instruction to the installer determination unit 124 (step S301). In response to the instruction, the installer determination unit 124 requests the program information acquisition unit 1230 to acquire the program information (step S302).

In response to the request for acquisition of the program information from the UI 122, the program information acquisition unit 1230 acquires the program information from the installation package 1061 (step S303, step S304). The program information acquisition unit 1230 transfers the acquired program information to the storing unit 104 and requests the storing unit 104 to write the transferred program information (step S305). In response to the request, the storing unit 104 writes the program information transferred from the program information acquisition unit 1230 in the OS management area 200 (step S306).

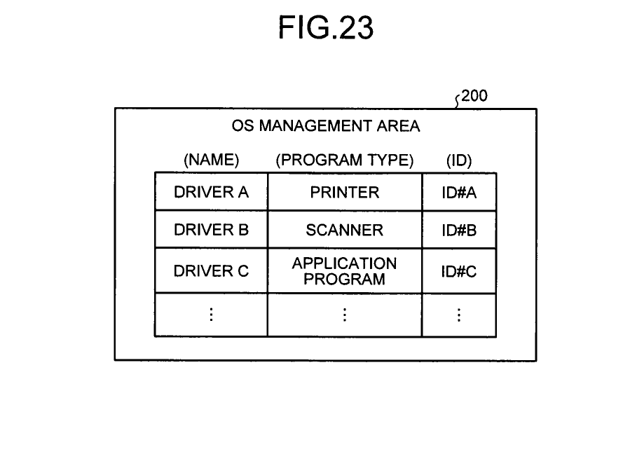

FIG. 23 illustrates an example of the program information written in the OS management area 200 according to the second embodiment. In this example, the ID of the program included in the program information, the class information (printer, scanner, or application program) of the program, and the name of the program are written in the OS management area 200 in association with each other. In the example of FIG. 23, the class information is written as the program type.

In addition, the program information acquisition unit 1230 transfers the program information acquired in steps S303 and 5304 to the installer determination unit 124 (step S307). The installer determination unit 124 determines the type of the program which is to be installed by the installation package 1061 based on the class information included in the program information transferred from the program information acquisition unit 1230 (step S308).

In the case where it is determined by the installer determination unit 124 in step S308 that the program which is to be installed by the installation package 1061 is the printer driver 106a, the process of step S3000 is performed, so that the installation of the printer driver 106a is executed. In the case where it is determined in step S308 that the program which is to be installed is the scanner driver 106b, the process of step S3001 is performed, so that the installation of the scanner driver 106b is executed. In addition, in the case where it is determined in step S308 that the program which is to be installed is the application program 106c, the process of step S3002 is performed, so that the installation of the application program 106c is executed.

In step S3000, the installer determination unit 124 instructs the printer unit 1210 in the program installation unit 1210 to install the program by the installation package 1061 (step S310). The printer unit 1210 fetches the files from the installation package 1061 and performs the installation process for the printer driver 106a (step S311). If the installation process for the printer driver 106a is completed, the printer unit 1210 notifies the UI 122 of that fact (step S312).

In step S3001, the installer determination unit 124 instructs the scanner unit 1211 to install the program by the installation package 1061 (step S310′). The scanner unit 1211 fetches the files from the installation package 1061 and performs the installation process for the scanner driver 106b (step S311′). If the installation process for the scanner driver 106b is completed, the scanner unit 1211 notifies the UI 122 of that fact (step S312′).

In addition, in step S3002, the installer determination unit 124 instructs the application program unit 1212 to install the program by the installation package 1061 (step S310″). The application program unit 1212 fetches the files from the installation package 1061 and performs the installation process for the application program 106c (step S311″). If the installation process for the application program 106c is completed, the application program unit 1212 notifies the UI 122 of that fact (step S312″).

If the completion of the installation process is reported from the printer unit 1210, the scanner unit 1211, or the application program unit 1212 of the program installation unit 1215, the UI 122 instructs the display unit 100 to display that fact (step S313). The display unit 100 displays that the installation is completed on the display 56 according to the instruction.

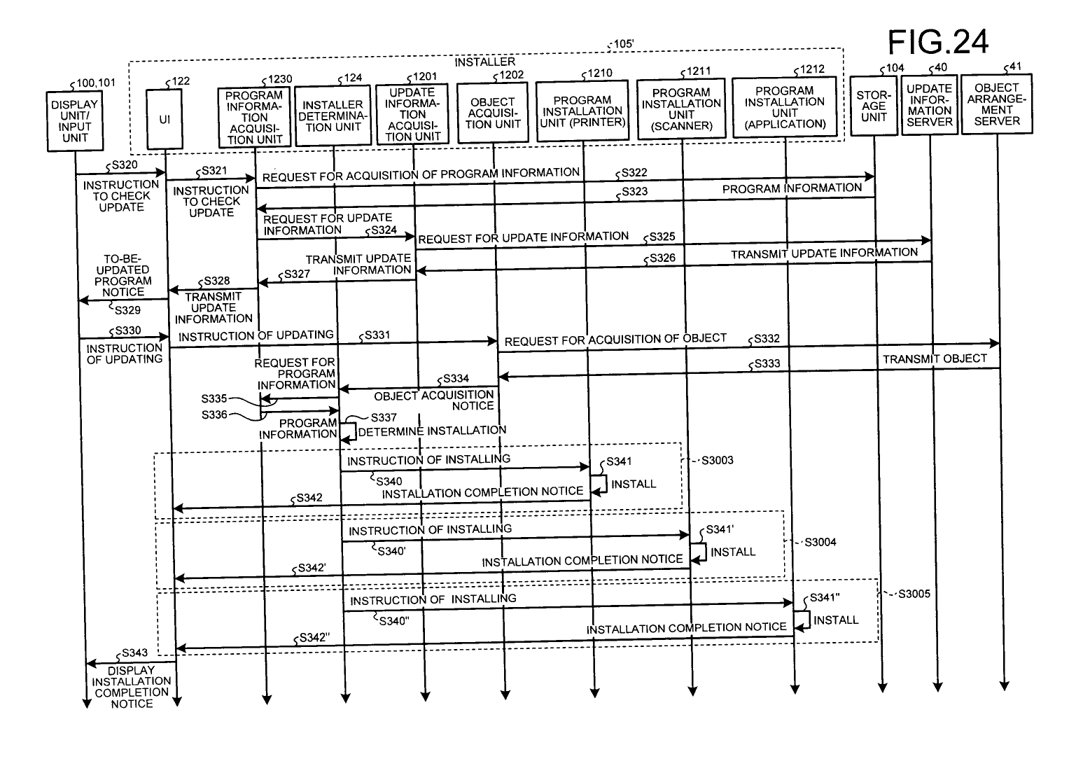

FIG. 24 is a flowchart illustrating an example of the update procedure for the program according to the second embodiment. Incidentally, in FIG. 24, the same components as those of FIGS. 1, 2, 20, and 21 described above are denoted by the same reference numerals, and the description thereof is omitted. In addition, hereinafter, appropriately, the printer driver 106a, the scanner driver 106b, and the application program 106c are representatively referred to as a “program”.

With respect to the processes illustrated in FIG. 24, the processes after the update check is instructed in response to user's manipulation in step S320 until the object is transmitted from the object arrangement server 41 in step S333 are substantially the same as the processes in steps S220 to S233 of FIG. 18 described in the modified example of the first embodiment.

That is, for example, in response to user's manipulation on the input unit 101 of the client PC 10, the UI 122 of the installer 105′ is instructed to check the update of the program (step S320). The instruction can be transferred from the UI 122 to the program information acquisition unit 1230 (step S321).

The program information acquisition unit 1230 receives the instruction of the update check and requests the storing unit 104 to acquire the program information (step S322). In response to the request, the storing unit 104 acquires from the OS management area 200 all of the program information where the ID, the class information, and the program are written in association with each other. The storing unit 104 transfers the acquired program information to the program information acquisition unit 1230 (step S323).

The program information acquisition unit 1230 selects the program information of the program, which the installer 105′ can cope with, from the program information transferred from the storing unit 104. For example, the program information acquisition unit 1230 determines based on the ID included in the program information whether or not the program information is the program which the installer 105′ can cope with. The determination is performed, for example, by determining whether or not the ID in accordance with the above-described predetermined format can be acquired from the program information.

The program information acquisition unit 1230 transfers the IDs acquired in the processes of steps S322 and S323 to the update information acquisition unit 1201 and requests the update information acquisition unit 1201 to acquire the update information corresponding to the IDs (step S324). The update information acquisition unit 1201 generates the specification information based on the IDs transferred from the program information acquisition unit 1230 and requests the update information server 40 to send the update information according to the generated specification information (step S325). In response to the request, the update information acquisition unit 1201 acquires the update information transmitted from the update information server 40 (step S326).

In this example, it is assumed that the update information for updating the printer driver 106a, the update information for updating the scanner driver 106b, and the update information for updating the application program 106c are transmitted from the update information server 40 and are acquired by the update information acquisition unit 1201.

The update information acquired with respect to the IDs is transferred from the update information acquisition unit 1201 through the program information acquisition unit 1230 to the UI 122 (step S327, step S328). The UI 122 transfers the transferred update information to the display unit 100 (step S329).

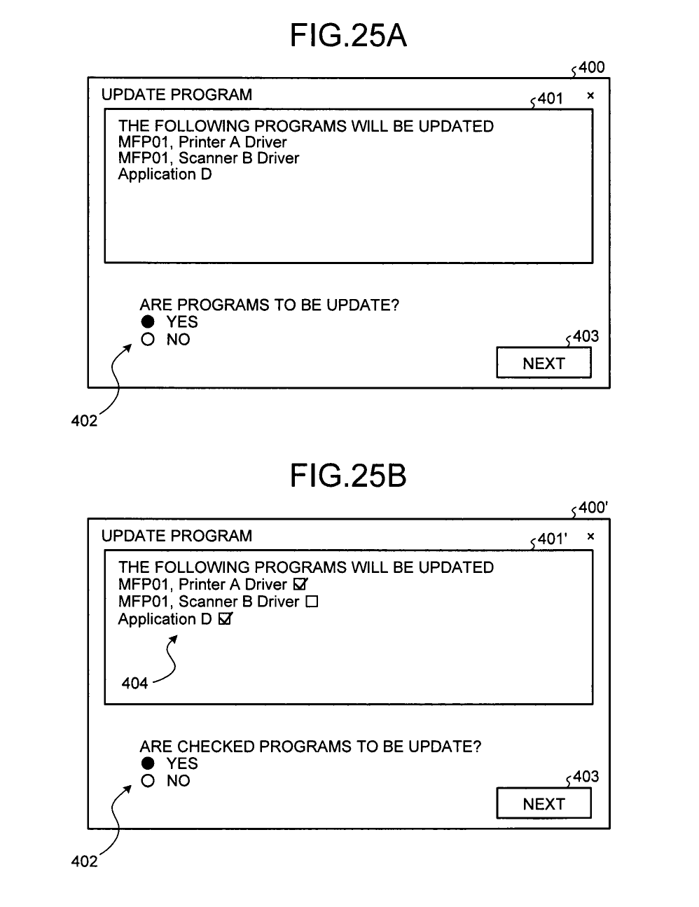

The display unit 100 displays the display screen illustrating the to-be-updated program on the display 56 based on the update information transferred from the UI 122. FIG. 25A illustrates an example of the display screen displayed by the display unit 100 according to the second embodiment. In the example of FIG. 25A, the display screen 400 displays a list of type names corresponding to the to-be-updated programs, the class information, and the program types in an area 401.

For example, the installer 105′ acquires the program information from the program having the ID which is coincident with the ID included in the update information reported from the UI 122 among the programs which are previously installed in the client PC 10 and displays the type name, the information indicating the class information, and the program type on the display screen 400 based on the acquired program information. In this example, on the display screen 400, the type name “MFP01”, the information “Printer A” indicating the class information of the printer, and the “Driver” indicating the program type or the type name “MFP01”, the information “Scanner B” indicating the class information of the scanner, and the “Driver” indicating the program type are displayed in association with each other. In addition, with the respect to the application program 106c, on the display screen 400, only the information “Application D” indicating the class information of the application program is displayed, and others are omitted. In this case, with respect to the MFP having the type name “MFP01”, it is illustrated that the printer driver 106a and the scanner driver 106b are updated and the application program 106c is updated.

In the display screen 400, the selection input unit 402 selects whether or not the program displayed in the area 401 is to be updated according to manipulation on the input unit 101. In the example of FIG. 25A, by selecting “Yes” in the selection input unit 402 and manipulating a button 403, the updating of each program displayed in the area 401 is started.

In addition, as illustrated in FIG. 25B, the display unit 100 may display a display screen 400′ by which the to-be-updated program can be selected. In the display screen 400′, with respect to the list of the to-be-updated programs displayed in the area 401′, check boxes 404 are added to the lines. In this case, the updating process is selectively executed on the program illustrated in the line whose check box 404 is checked by manipulation on the input unit 101.

The UI 122 is notified of the program updating manipulation on the display screen 400 from the input unit 101 (step S330). The UI 122 transfers the update information of the to-be-updated program to the object acquisition unit 1202 and instructs the object acquisition unit 1202 to update the program (step S331).

The object acquisition unit 1202 transmits a request for object acquisition to the object arrangement server 41 based on the update information transferred from the UI 122 (step S332) and acquires the object transmitted from the object arrangement server 41 in response to the request (step S333). If the object is acquired, the object acquisition unit 1202 transfers the notice of object acquisition together with the ID corresponding to the acquired object to the installer determination unit 124 (step S334).

The installer determination unit 124 transfers the ID transferred from the object acquisition unit 1202 to the program information acquisition unit 1230 and requests the program information acquisition unit 1230 to send the program information corresponding to the ID (step S335). In response to the request, the program information acquisition unit 1230 transfers the transferred program information corresponding to the ID to the installer determination unit 124 (step S336).

The installer determination unit 124 determines the type of the program which is to be installed by the updating based on the class information included in the program information transferred from the program information acquisition unit 1230 (step S337).

In the case where it is determined by the installer determination unit 124 in step S337 that the program which is to be installed by the updating is the printer driver 106a, the process of step S3003 is performed, so that the printer driver 106a is installed and the printer driver 106a is updated. In the case where it is determined in step S337 that the program which is to be installed is the scanner driver 106b, the process of step S3004 is performed, so that the scanner driver 106b is installed and the scanner driver 106b is updated. In addition, in the case where it is determined in step S337 that the program which is to be installed is the application program 106c, the process of step S3005 is performed, so that the application program 106c is installed and the application program 106c is updated.

In step S3003, the installer determination unit 124 instructs the printer unit 1210 of the program installation unit 1215 to install the program by the object acquired in step S333 by the object acquisition unit 1202 (step S340). The printer unit 1210 executes the installation process for the object acquired by the object acquisition unit 1202 according to the instruction (step S341), and if the installation process is completed, the printer unit notifies the UI 122 of that fact (step S342).

In step S3004, the installer determination unit 124 instruct the scanner unit 1211 of the program installation unit 1215 to install the program by the object acquired in step S333 by the object acquisition unit 1202 (step S340′). The scanner unit 1211 executes the installation process for the object acquired by the object acquisition unit 1202 according to the instruction (step S341′), and if the installation process is completed, the scanner unit notifies the UI 122 of that fact (step S342′).

In addition, in step S3005, the installer determination unit 124 instructs the application program unit 1212 of the program installation unit 1215 to install the program by the object acquired in step S333 by the object acquisition unit 1202 (step S340″). The application program unit 1212 executes the installation process for the object acquired by the object acquisition unit 1202 according to the instruction (step S341″), and if the installation process is completed, the application program unit notifies the UI 122 of that fact (step S342″).

If the completion of the installation process is reported from the printer unit 1210, the scanner unit 1211, or the application program unit 1212 of the program installation unit 1215, the UI 122 instructs the display unit 100 to display that fact (step S343). The display unit 100 displays that the installation is completed on the display 56 according to the instruction.

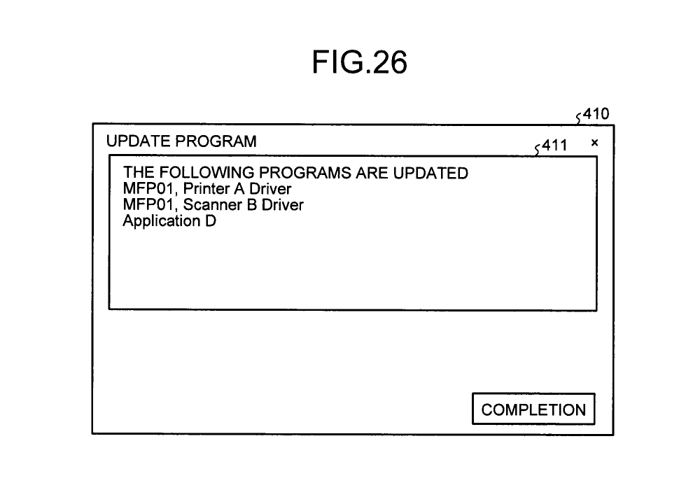

FIG. 26 illustrates an example of the installation completion screen which the display unit 100 displays on the display 56 according to the second embodiment. In FIG. 26, the installation completion screen 410 displays a list of the programs which are installed and updated in the area 411.

According the second embodiment, even with respect to the printer driver 106a, the scanner driver 106b, and the application program 106c whose program types are different from each other, the installer 105′ acquires the update information including the URLs of the objects used for updating the printer driver 106a, the scanner driver 106b, and the application program 106c according to the specification information (for example, URLs) based on the identification information (ID) included in the program information of the printer driver 106a, the scanner driver 106b, and the application program 106c written in the OS management area 200. The installer 105′ can perform the installation process according to the program type based on the class information included in the program information.

In addition, even in the case where each update information stored in the storage location specified by the specification information based on the identification information included in the printer driver 106a, the scanner driver 106b, and the application program 106c is an unknown program when the printer driver 106a, the scanner driver 106b, or the application program 106c is installed, the installer 105′ may install the unknown program in the client PC 10 based on the update information.

Incidentally, although the above-described embodiments and the modified examples are very appropriate examples for embodying the invention, the invention is not limited thereto, but various modifications are available within the scope of the invention without departing from the spirit of the invention.

According to an embodiment, it is possible to obtain an effect in that one installer is enabled to be commonly applicable to a current provided program and a program which will be provided in the future.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a first acquisition unit which acquires identification information identifying a driver from the driver;
a generation unit which generates specification information specifying a storage location where update information for updating the driver is stored, based on the identification information; and
a second acquisition unit which acquires the update information from the storage location specified by the specification information generated by the generation unit.

2. The information processing apparatus according to claim 1, wherein
the specification information includes the identification information in accordance with a predefined rule, and
the generation unit generates the specification information from the identification information in accordance with the rule.

3. The information processing apparatus according to claim 1, wherein the first acquisition unit determines whether or not the driver includes the identification information and acquires the identification information from the driver according to a determination result.

4. The information processing apparatus according to claim 1, wherein the second acquisition unit determines whether or not the driver is to be updated, based on the update information, and displays information indicating the driver determined to be updated on a display unit.

5. The information processing apparatus according to claim 1, wherein the first acquisition unit acquires the identification information from the driver and stores the identification information in a predefined area of the computer at the time of installing the driver, and acquires the identification information from the storage area at the time of updating the driver.

6. The information processing apparatus according to claim 5, wherein the first acquisition unit further acquires type information indicating a type of the driver from the driver and stores the type information in the storage area in association with the identification information.

7. The information processing apparatus according to claim 6, further comprising an update unit that updates the driver by using the update information acquired by the second acquisition unit, wherein
the update unit acquires the type information from the storage area and updates the driver by a procedure according to a type of the driver indicated by the acquired type information.

8. An information processing method comprising:
first acquiring identification information identifying a driver from the driver;
generating specification information specifying a storage location where update information for updating the driver is stored, based on the identification information; and
second acquiring the update information from the storage location specified by the specification information generated at the generating.

9. An information processing system comprising:
a first storage unit which stores an object for updating a driver in a first storage location;
a second storage unit which stores update information including information indicating the first storage location, in a second storage location specified by specification information based on identification information identifying the driver;
a first storing unit which stores a driver including the identification information identifying the driver itself;
a first acquisition unit which acquires the identification information from the driver stored in the first storing unit;
a generation unit which generates the specification information based on the identification information acquired by the first acquisition unit;
a second acquisition unit which acquires the update information from the second storage location specified by the specification information generated by the generation unit; and
an updating unit which acquires the object from the first storage unit based on the update information acquired by the second acquisition unit and updates the driver stored in the first storing unit by using the acquired object.
